(19) United States
(12) Patent Application Publication
(10) Pub. No.: US 2023/0397244 A1
(43) Pub. Date: Dec. 7, 2023

(54) METHODS AND SYSTEMS FOR MANAGING WIRELESS COMMUNICATIONS

(71) Applicant: COMCAST CABLE COMMUNICATIONS, LLC, Philadelphia, PA (US)

(72) Inventors: Colleen Szymanik, Philadelphia, PA (US); Teddy El-Rashidy, Philadelphia, PA (US); Ravi Teja Pandirla, Philadelphia, PA (US); Leslie Alvarado, Philadelphia, PA (US); Firas Shaari, Philadelphia, PA (US)

(21) Appl. No.: 17/829,993

(22) Filed: Jun. 1, 2022

(51) Int. Cl. H04W 72/12; H04W 28/06

(52) U.S. Cl. CPC H04W 72/1242; H04W 72/1278; H04W 28/06

(57) ABSTRACT

A networking device may determine that communications that is it receiving or sending to a computing device would not use all of the bandwidth of a channel when those communications are being sent or received. The networking device may determine other communications from the computing device or other computing devices to send communications to or from. The networking device may allocate different portions of the bandwidth for each of those communications to be sent or received by the networking device.

### BACKGROUND

Wireless networks rely on the use of bandwidth of a channel to send data from one device to another. The amount of data to be sent by a device may use all or a portion of the bandwidth of the channel. When only a portion of the bandwidth of the channel is used to send data from a device, it reduces the efficiency of the wireless network, since there is a portion of the bandwidth that goes unused during the particular transmission from the device.

### SUMMARY

It is to be understood that both the following general description and the following detailed description are exemplary and explanatory only and are not restrictive. Methods and systems for managing wireless communications are described.

A networking device may determine that communications that is it receiving or sending would not use all of the bandwidth when those communications are being sent or received. The networking device may determine other devices to send communications to or from and may allocate different portions of the bandwidth for each of those communications to be sent or received.

This summary is not intended to identify critical or essential features of the disclosure, but merely to summarize certain features and variations thereof. Other details and features will be described in the sections that follow.

### BRIEF DESCRIPTION OF THE DRAWINGS

The accompanying drawings, which are incorporated in and constitute a part of the present description serve to explain the principles of the apparatuses and systems described herein:

FIG. 1 shows an example system for managing wireless communications;

FIG. 2 shows a block diagram for an example system for combining communications to be sent to one or more devices;

FIG. 3 shows a block diagram for an example system of combining communications to be received from one or more devices;

FIG. 4 shows a flowchart of an example method for managing wireless communications to one or more devices;

FIG. 5 shows a flowchart of an example method for managing wireless communications received from one or more devices;

FIG. 6 shows a flowchart of an example method for managing wireless communications to one or more devices;

FIG. 7 shows a flowchart of an example method for managing wireless communications received from one or more devices;

FIG. 8 shows a flowchart of an example method for managing wireless communications received from one or more devices; and

FIG. 9 shows a block diagram of an example computing device for managing wireless communications.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. When values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude other components, integers or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, a computer program product on a computer-readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, memresistors, Non-Volatile Random Access Memory (NVRAM), flash memory, or a combination thereof.

Throughout this application reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Accordingly, blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

This detailed description may refer to a given entity performing some action. It should be understood that this language may in some cases mean that a system (e.g., a computer) owned and/or controlled by the given entity is actually performing the action.

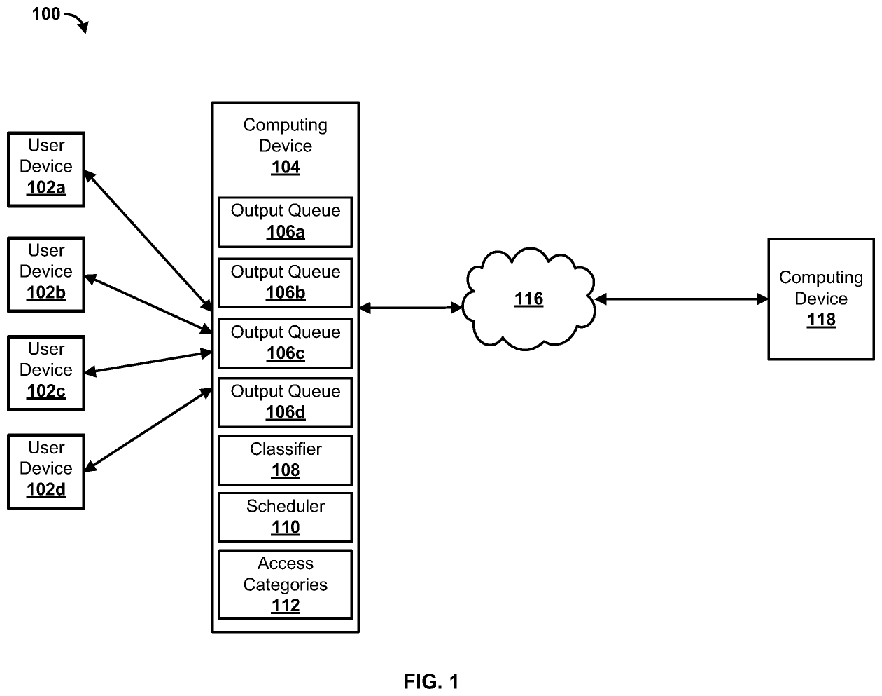

FIG. 1 shows an example system 100. The example system 100 may be configured for managing wireless communications between a plurality of devices. Although only certain devices and/or components are shown, the system 100 may comprise a variety of other devices and/or components that support a wide variety of network and/or communication functions, operations, protocols, and/or the like.

The system 100 may comprise a computing device 104. The computing device 104 may be a network device. For example, the computing device 104 may comprise an access point, edge device, switch, network device, router, gateway, or the like. The computing device 104 may be configured to receive wireless and/or wired communications. For example, data may be sent and/or received by the computing device 104 via a variety of wireless transmission paths and/or wired transmission paths. For example, the wireless communication may be at least one of Wi-Fi, Bluetooth, Bluetooth Low-Energy (BLE), Zighee, Z-Wave, 6LoWPAN, WiFi Direct, near field communication (NFC). Long Range (LoRa), LoRaWAN, satellite, cellular, etc. For example, the computing device 104 may be configured to communicate with other computing devices according to the Wi-Fi 6 (802.11ax) wireless protocol.

The computing device 104 may be configured to communicate with a plurality of user devices (e.g., user devices 102a-d). For example, the computing device 104 may be configured to communicate wirelessly with the user devices 102a-d. The computing device 104 may be configured to send and/or receive data from each of the user devices 102a-d. The data may comprise any form of data, including voice data, video data, audio-video data, network data, application data, etc. The data may be received by the computing device 104 from other computing devices (e.g., the computing device 118) via a wired or wireless network (e.g., network 116).

The computing device 104 may comprise one or more output queues. For example, the computing device 104 may comprise output queues 106a-d. While the example of FIG. 1 shows four output queues 106a-d (e.g., a queue 106a, a second queue 106b, a third queue 106c, and a fourth queue 106d), this is for example, purposes only, as the computing device 104 may have any number of output queues less than or greater than the four output queues shown. Each output queue 106a-d may be configured to store a plurality of packets or data waiting to be sent or otherwise transmitted by the computing device 104 to another computing device (e.g., one or more of the user devices 102a-d).

For example, each output queue 106a-d may be associated with data or packets assigned to, or a part of, a single quality of service (QoS) priority level. For example, the computing device 104 may store each packet or data in the output queue 106a-d that corresponds with the QoS priority level of the particular packet or data. For example, the output queue 106a may be configured as a queue for packets having a highest QoS priority level. For example, the highest QoS priority level may be level 1, voice, or high priority. For example, the output queue 106b may be configured as a queue for packets having a second highest QoS priority level. For example, the second highest QoS priority level may be level 2, video, or medium priority. For example, the output queue 106c may be configured as a queue for packets having a third highest QoS priority level. For example, the third highest QoS priority level may be level 3, best efforts, or normal priority. For example, the output queue 106d may be configured as a queue for packets having the lowest QoS priority level. For example, the lowest QoS priority level may be level 4, background, or low priority. For example, the computing device 104 may prioritize sending and receiving packets having a higher QoS priority level over those having a lower QoS priority level.

For example, the computing device 104 may comprise a classifier 108. The classifier 108 may be configured as a module or software within the computing device 104. For example, the classifier 108 may be configured to evaluate the access categories 112 to determine what QoS priority level to assign to, or associate with, each packet or data received by the computing device 104. For example, the classifier 108 may use network based application recognition (NBAR) to determine what QoS priority level to assign to, or associate with, each packet or data received by the computing device 104.

For example, the classifier 108 may insert an indication of the assigned QoS priority level into each packet or data received by the computing device 104. For example, the classifier 108 may insert the indication into a “type of service” field or another field of the IP header of the packet or data. For example, the classifier 108, or any other portion, of the computing device 104 may use differentiated services code point (DSCP) to insert the indication of the assigned QoS priority level into the packet or data.

The computing device 104 may comprise access categories 112. For example, the access categories 112 may be a database, table, or listing of data within the computing device 104. For example, the access categories 112 may indicate the QoS priority level to assign to, or associate with, the packet or data based on the particular form or type of data. For example, the classifier 108 may determine the type of data received by the computing device 104 and use a lookup table of the access categories to determine the QoS priority level associated with the particular data type.

The computing device 104 may comprise a scheduler 110. The scheduler 110 may be configured as a module or software within the computing device 104. The scheduler 110 may be configured to evaluate the packets or data in the output queues 106a-d and the QoS priority level of each of those packets or data. The scheduler 110 may be configured to determine if the packets or data will use a predetermined amount of the bandwidth of the channel when the packets or data are sent by the computing device 104 to another computing device (e.g., the user devices 102a-d. The scheduler 110 may be configured to determine additional packets or data to include when the packets or data being sent will not use the predetermined amount of the bandwidth of the channel. The scheduler 110 may be configured to combine the additional packets or data with the packets or data to be sent into the multi-device packet that may be sent to multiple other computing devices at the same time.

For example, the scheduler 110 may be configured to evaluate the packets or data in the output queues of other computing devices (e.g., user devices 102a-d) that are waiting to send the packets or data to the computing device 104. For example, the computing device 104 may send a buffer status report trigger frame to the user devices 102a-d via the network 116 or another network. For example, the computing device 104, in response the buffer status report trigger frame, may receive a buffer status report from one or more of the user devices 102a-d. The buffer status report may indicate the packets or data the particular user device 202a-d has buffered and that are waiting to be sent to the computing device 104. The scheduler 110 may be configured to evaluate the buffer status reports for each of the user devices 102a-d. The scheduler 110 may be configured to determine the data or packets to be sent by each user device 102a-d and the QoS priority level of those packets or data. The scheduler 110 may be configured to determine if a particular user device will use a predetermined amount of the bandwidth of the channel when sending the packet(s) or data from the user device to the computing device 104. The scheduler 110 may be configured to determine additional packet(s) or data to be sent to the computing device 104 when the packets or data being received by the computing device 104 will not use the predetermined amount of the bandwidth of the channel. The scheduler 110 may be configured to divide up the bandwidth of the channel between one or more user devices 102a-d sending the packet and the additional packet and indicating a time each of the user devices 102a-d should send the packet(s) and the additional packet(s).

The system 100 may comprise one or more user devices 102a-d. While the example of FIG. 1 shows four user devices 102a-d, this is for example purposes only, as the system 100 can have any number of user devices 102a-d. Each user device 102a-d may be configured to communicate wirelessly with the computing device 104. Each user device 102a-d may be configured to send packets or data to and/or receive packets or data from the computing device 104. For example, one or more of the user devices 102a-d may comprise an output queue. The output queue may be configured to store a plurality of packets or data waiting to be sent or otherwise transmitted by the particular user device 102a-d to another computing device (e.g., the computing device 104). The user devices 102a-d may comprise one or more of a client device, a personal computer, computing station, workstation, portable computer, laptop computer, mobile phone, tablet device, smartphone, smartwatch, activity tracker, smart apparel, smart accessory, security and/or monitoring device, a mobile device, a game system, a content output device, an IoT device, an edge device, an access point, a gateway, a network device, or the like.

The user devices 102a-d, computing device 104, and other computing devices 118 comprise a plurality of computing devices in communication via a network 118. The network 118 may be multiple networks and may comprise one or more of an optical fiber network, a coaxial cable network, a hybrid fiber-coaxial network, a wireless network, a satellite system, a direct broadcast system, an Ethernet network, a high-definition multimedia interface network, a Universal Serial Bus (USB) network, or any combination thereof. Data may be sent on the network 116 via a variety of transmission paths, including wireless paths (e.g., satellite paths, Wi-Fi paths, cellular paths, etc.) and terrestrial paths (e.g., wired paths, a direct feed source via a direct line, etc.). The network 116 may comprise public networks, private networks, wide area networks (e.g., Internet), local area networks, and/or the like. The network 116 may be configured to send or otherwise transmit data or packets between the computing device 104 and the plurality of user devices 102a-d using a variety of network paths, protocols, devices, and/or the like.

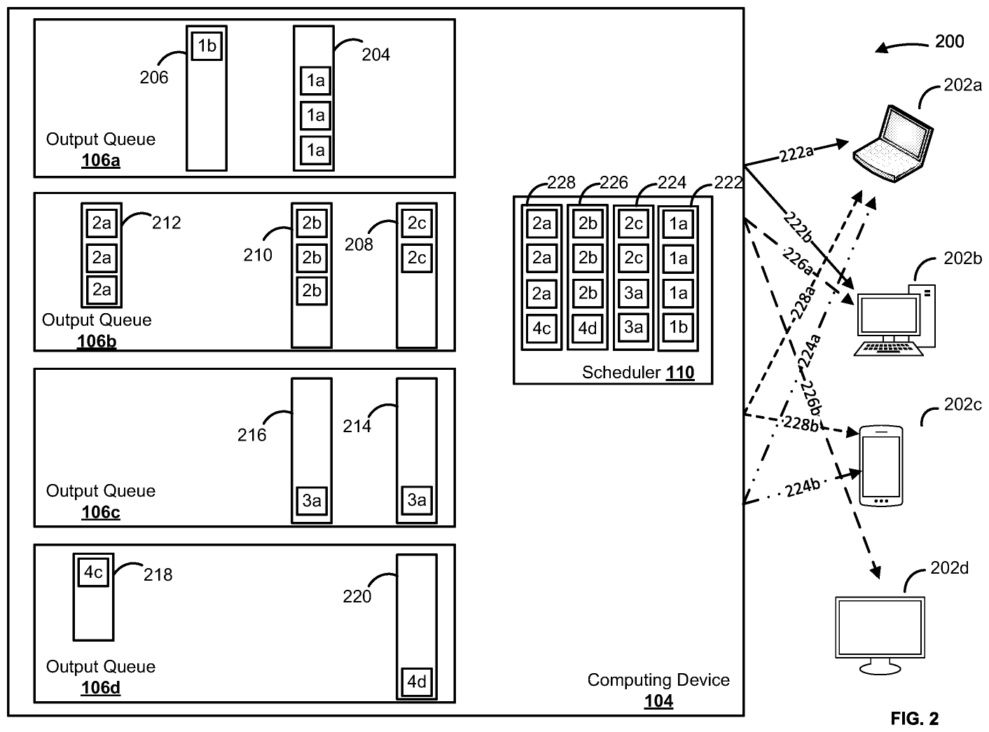

FIG. 2 shows a block diagram for an example system 200 for combining communications to be sent to one or more devices (e.g., one or more user devices 202a-d). Although only certain devices and/or components are shown, the system 200 may comprise a variety of other devices and/or components that support a wide variety of network and/or communication functions, operations, protocols, and/or the like. The system 200 may comprise a plurality of computing devices and/or user devices in the network. The network may be a wireless network. Data may be sent on the network via a variety of wireless transmission paths (e.g., satellite paths, Wi-Fi paths, cellular paths, etc.). The network may comprise public networks, private networks, wide area networks (e.g., Internet), local area networks, and/or the like. The network may be configured to provide data for a plurality of user devices 202a-d using a variety of network paths, protocols, devices, and/or the like. The network may deliver data for a plurality of user devices 202a-d from the computing device 104 (e.g., an access point, edge device, network device, router, gateway, etc.).

The system 200 may comprise the computing device 104, which may include the scheduler 110 and one or more output queues 106a-d. The scheduler 110 may be a module or software within the computing device 104 that is configured to schedule how packets are received from multiple computing devices (e.g., the user devices 202a-d) by the computing device 104 and how packets are sent by the computing device 104 to the multiple computing device (e.g., the user device 202a-d). The computing device 104 may receive data from one or more remote computing devices and may distribute that data to the one or more user devices 202a-d. The data may comprise any form of data, including voice data, video data, audio-video data, network data, application data, etc. The data may be received by the computing device 104 via a wired or wireless network and may be sent by the computing device 104 to the one or more user devices 202a-d via a wireless network. For example, the wireless network may be any one of a Wi-Fi, Bluetooth, Bluetooth Low-Energy (BLE), Zigbee, Z-Wave, 6LoWPAN, WiFi Direct, near field communication (NEC). Long Range (LoRa). LoRaWAN, etc. For example, the wireless network may be configured to operate according to the Wi-Fi 6 (802.11ax) wireless protocol.

The system 200 may also comprise one or more user devices (e.g., user devices 202a-d). While the example of FIG. 2 shows four user devices 202a-d, this is for example purposes only, as the system 200 may comprise fewer or greater than four user devices 202a-d. The user devices 202a-d may comprise one or more of a client device, a personal computer, computing station, workstation, portable computer, laptop computer, mobile phone, tablet device, smartphone, smartwatch, activity tracker, smart apparel, smart accessory, security and/or monitoring device, a mobile device, a game system, a content output device, an IoT device, an edge device, an access point, a gateway, a network device, or the like. Each user device 202a-d may be configured to communicate via a wireless communication protocol with the computing device 104. For example, each user device 202a-d may be configured to communicate with the computing device 104 via the Wi-Fi 6 (802.11ax) wireless protocol.

The computing device 104 may receive data in the form of packets via a wired or wireless network from any gateway 114, the user devices 202a-d, or another computing device via the network 116. The scheduler 110 of the computing device 104 may be configured to combine data packets from multiple message payloads having the same or different quality of service (QoS) priority level. The scheduler 110 of the computing device 104 may also be configured to combine data packets from multiple message payloads having the same or different destination (e.g., one of the user devices 202a-d).

The computing device 104 may determine the QoS priority level assigned to, or associated with, each received packet of the plurality of packets. For example, the computing device 104 may assign or associate a QoS priority level to each packet of the plurality of packets. For example, the computing device 104 may insert an indication of the assigned QoS priority level into each packet of the plurality of packets. For example, one or more of the plurality of packets may have previously been assigned the QoS priority level (e.g., by another computing device and/or prior to being received by the computing device 104). For example, the computing device 104 may evaluate each of these packets to identify the indicator of the assigned QoS priority level and determine, based on the indicator, the assigned QoS priority level.

The computing device 104 may place each packet of the plurality of packets into a queue. For example, the computing device 104 may include a plurality of queues (e.g., the output queues 106a-d). For example, the computing device 104 may include a separate queue for each QoS priority level. For example, the computing device 104 may store each packet in a queue that corresponds with the QoS priority level of the individual packet. For example, the output queue 106a may be configured as a queue for packets having a highest QoS priority level (e.g., level 1, voice, or high priority), the output queue 106b may be configured as a queue for packets having a second highest QoS priority level (e.g., level 2, video, or medium priority), the output queue 106c may be configured as a queue for packets having a third highest QoS priority level (e.g., level 3, best efforts, or normal priority), and the output queue 106d may be configured as a queue for packets having the lowest QoS priority level (e.g., level 4, background, or low priority). For example, the computing device 104 may prioritize sending packets having higher priority over those having lower priority.

For example, the computing device 104 may store a portion of the plurality of the packets in one or more message payloads (e.g., message payloads 204-220) within the queue 106a-d that the packet was assigned or included in. For example, each message payload may include one or a plurality of packets. For example, each message payload may be constructed to be sent by the computing device 104 to a single other computing device (e.g., user devices 202a-d).

The scheduler 110 or another portion of the computing device 104 may determine at least one packet (e.g., at least one first packet), to be sent or transmitted by the computing device 104. For example, the computing device 104 may determine the at least one packet to be sent by evaluating the output queues 106a-d of the computing device 104 in priority level order, from highest priority level queue 106a to lowest priority level queue 106d. The packets and the message payloads comprising the packets may be stored in their respective output queues 106a-d in chronological order and optionally configured to be sent by the computing device 104 to one or more other computing device in a first-in, first out (FIFO) order.

For example, the computing device 104 may determine a message payload (e.g., a first message payload, such as the message payload 204 in the output queue 106a) includes one or a plurality of packets having a highest priority (e.g., priority level 1, voice, or high) and the message payload 204 is configured to be sent to user device 202a. The computing device 104 may determine that the at least one packet (e.g., data) within the message payload 204, when sent, would use only a portion of the bandwidth of the channel used by the computing device 104 for sending data to other computing devices.

For example, the computing device 104 may evaluate the total length field of the packet or packets that make up the message payload 204 to determine the total number of bytes within the packet. For example, the computing device 104 may determine the total number of bytes within the packet or packets of the message payload 204, based on the total length field of each packet, as the size of the packet or packets within the message payload 204 and may compare that amount to the amount of data space available in the bandwidth of the channel used by the computing device 104 for sending data to other computing devices. For example, the computing device 104 may evaluate the total length field of the packet or packets that make up the message payload 204 to determine the total number of bytes within the packet. The computing device 104 may then subtract the number of 32-bit words that make up the header (e.g., provided in the header length field of each packet) to determine the size of each packet that makes up the message payload 204. The computing device 104 may then compare the determined size of the message payload 204 (e.g., based on the combined size or sum of each packet within the payload 204) to the amount of data space available in the bandwidth of the channel used by the computing device 104 for sending data to other computing devices.

Based on the message payload 204 not needing all of the bandwidth of the channel for sending the message payload 204 to user device 202a, the computing device 104 may evaluate the same output queue 106a, or any other packets or message payloads having the same QoS priority level, for other data (e.g., message payloads) to combine with the message payload 204 for sending at the same time within the bandwidth of the channel. The computing device 104 may determine the at least one second packet to be sent by evaluating the other message payloads comprising one or more packets that would fit within the remaining portion of the bandwidth of the channel used by the computing device 104. For example, the computing device 104 may determine the at least one second packet in the message payload 206 (e.g., a second message payload 206) has the same QoS priority level as the message payload 204, and is of a data size that it would use (e.g., could be sent within) a second portion (e.g., a remaining portion) of the bandwidth of the channel for sending along with the at least one packet in the message payload 204. For example, the computing device 104 may determine the data size of the second packet in the message payload 206 based on the total length field or the total length field and the header length field of the second packet. The process may continue in substantially the same manner until a sufficient number of packets are obtained from the plurality of message payloads having the first QoS priority level to use a predetermined amount of the bandwidth of the channel for simultaneous sending to other computing devices by the computing device 104. The scheduler 110 or another portion of the computing device 104 may combine the data packets of the message payload 204 and the data packets of the message payload 206 into the multi-device packet (e.g., multi-device packet 222).

For example, the multi-device packet 222 may be divided into a plurality of resource units. Each of the resource units may be associated with a frequency allocation range within the bandwidth of the channel. In the example provided above, the multi-device packet 222 may be divided into four resource units (e.g., a resource unit, another resource unit, yet another resource unit and an additional resource unit), however, in other examples, the number of resource units for the multi-device packet can be any number between 1-74 resource units. For example, the scheduler 110 of the computing device 104 may allocate, associate, determine, and/or assign three resource units of the multi-device packet 222 to the message payload 204 (e.g., cause the message payload 204 to make use of the three resource units), with each resource unit holding one of the three packets 1a. Each of the resource units (e.g., the resource unit, the another resource unit, and/or the yet another resource unit) may be configured to be sent over a different range of frequencies (e.g., corresponding frequency allocation (e.g., a first frequency allocation), another frequency allocation (e.g., a second frequency allocation), and a yet another frequency allocation (e.g., a third frequency allocation)) of the bandwidth of the channel. For example, the resource unit, the another resource unit, and the yet another resource unit may be combined into a single resource unit within the multi-device packet 222 to receive all of the message payload 204. For example, the combined resource unit, the another resource unit, and the yet another resource unit may be a single resource unit corresponding to a frequency allocation of the bandwidth of the channel. For example, the computing device 104 may allocate, associate, determine, and/or assign an additional resource unit (e.g., a fourth resource unit) of the multi-device packet 222 to the message payload 206 (e.g., cause the message payload 206 to use the data space associated with or included within the additional resource unit), with the additional resource unit holding the packet 1b of the message payload 206. For example, the additional resource unit (e.g., the fourth resource unit) may be assigned or associated with an additional frequency allocation (e.g., a fourth frequency allocation) within the bandwidth of the channel (e.g., cause the additional resource unit to be sent within a frequency range in the additional frequency allocation) that is different from the frequency allocation, the another frequency allocation, and the yet another frequency allocation and may be configured to be sent within a frequency range of the additional frequency allocation.

The computing device 104 may determine that no additional packets are in the output queue 106a and no additional packets are waiting to be sent that have the highest QoS priority value. The computing device 104 may then evaluate the output queue 106b for packets having the second highest QoS priority value (e.g., level 2, video, medium priority). The computing device 104 may determine that a message payload 208 (e.g., a third message payload 208) includes a plurality of packets having the second highest priority and the message payload 208 is configured to be sent to the user device 202c. The computing device 104 may determine that the plurality of packets within the message payload 208, when sent, would use only a portion of the bandwidth (e.g., a first portion of the bandwidth) of the channel used by the computing device 104 for sending data to other computing devices. For example, the computing device 104 may determine the data size of the plurality of packets in the message payload 208 based on the total length field or the total length field and the header length field of each of the plurality of packets. Based on the message payload 208 not needing all of the bandwidth of the channel for sending the message payload 208 to the user device 202c, the computing device 104 may evaluate the same output queue 106b for additional packets to combine with the packets of the message payload 208. The computing device 104 may determine that the output queue 106b includes two additional message payloads 210 and 212 but that each of the message payloads 210, 212 include too much data (or too many additional packets) based on the remaining portion of the bandwidth of the channel in order to be combined with the data in the message payload 208. The computing device 104 may then evaluate the message payloads in the output queue 106c having the third highest QoS priority value (e.g., level 3, best efforts, normal priority). The computing device 104 may determine that a message payload 214 (e.g., a fourth message payload 214) includes a packet having the third highest priority and the message payload 214 is configured to be sent to the user device 202a. The computing device 104 may determine that the packet within the message payload 214, when sent, would use only a portion of the bandwidth (e.g., a second portion of the bandwidth) of the channel used by the computing device 104 for sending data to other computing devices and that an additional remaining portion of the bandwidth may still be available to adding additional packets. For example, the computing device 104 may determine the data size of the packet in the message payload 214 based on the total length field or the total length field and the header length field of the second packet. The computing device 104 may evaluate any additional message payloads in the output queue 106c. The computing device 104 may determine that a message payload 216 (e.g., a fifth message payload 216) includes a packet having the third highest priority and the message payload 216 is configured to be sent to the user device 202a and will fit within the remaining portion of the bandwidth of the channel to be sent with the packets of the message payload 208 and the message payload 214. The scheduler 110 or another portion of the computing device 104 may combine the data packets of the message payload 208, message payload 214, and message payload into the multi-device packet (e.g., multi-device packet 224). For example, the scheduler 110 of the computing device 104 may allocate, associate, determine, and/or assign two resource units of the multi-device packet 224 to the message payload 208 (e.g., cause the message payload 208 to use the data space associated with or included within the two resource units), with each resource unit holding one of the two packets 2c. Each of the resource unit (e.g., a first resource unit) and the another resource unit (e.g., a second resource unit) may be configured to be sent over a different range of frequencies (e.g., the corresponding frequency allocation and the another frequency allocation) of the bandwidth of the channel. For example, the resource unit (e.g., the first resource unit) and the another resource unit (e.g., the second resource unit) may be combined into a single resource unit within the multi-device packet 224 to receive all of the message payload 208. For example, the combined resource unit and the another resource units may be a single resource unit corresponding to a frequency allocation of the bandwidth of the channel. For example, the computing device 104 may allocate, associate, determine, and/or assign a yet another resource unit (e.g., a third resource unit) of the multi-device packet 224 to the message payload 214 (e.g., cause the message payload 214 to use the data space associated with or included within the yet another resource unit), with the yet another resource unit (e.g., the third resource unit) holding the packet 3a of the message payload 214. For example, the yet another resource unit (e.g., the third resource unit) may be associated with or assigned a yet another frequency allocation within the bandwidth of the channel (e.g., cause the yet another resource unit to be sent within a frequency range in the yet another frequency allocation) that is different from the frequency allocation and the another frequency allocation. For example, the computing device 104 may allocate, associate, determine, and/or assign an additional resource unit (e.g., the fourth resource unit) of the multi-device packet 224 to the message payload 216 (e.g., cause the message payload 216 to use the data space associated with or included within the additional resource unit), with the additional resource unit (e.g., the fourth resource unit) holding the packet 3a of the message payload 216. For example, the additional resource unit (e.g., the fourth resource unit) may be associated with or assigned an additional frequency allocation within the bandwidth of the channel (e.g., cause the additional resource unit to be sent within a frequency range in the additional frequency allocation) that is different from the frequency allocation, the another frequency allocation, and the yet another frequency allocation.

The computing device 104 may again determine that no additional packets are in the output queue 106a or waiting to be sent that have the highest QoS priority value. The computing device 104 may again evaluate the output queue 106b for packets having the second highest QoS priority value. The computing device 104 may determine that a message payload 210 (e.g., a sixth message payload 210) includes a plurality of packets having the second highest priority and the message payload 210 is configured to be sent to the user device 202b. The computing device 104 may determine that the plurality of packets within the message payload 210, when sent, would use only a portion of the bandwidth (e.g., a first portion of the bandwidth) of the channel used by the computing device 104 for sending data to other computing devices. For example, the computing device 104 may determine the data size of the plurality of packets in the message payload 210 based on the total length field or the total length field and the header length field of each of the plurality of packets. Based on the message payload 210 not needing all of the bandwidth of the channel for sending the message payload 210 to the user device 202c, the computing device 104 may evaluate the same output queue 106b for additional packets to combine with the packets of the message payload 210. The computing device 104 may determine that the output queue 106b includes one additional message payload 212 but that it includes too much data (or too many additional packets) based on the remaining portion of the bandwidth of the channel in order to be combined with the data in the message payload 210. The computing device 104 may then evaluate the message payloads in the output queue 106c having the third highest QoS priority value. The computing device 104 may determine that there are no packets in the output queue 106c waiting to be sent. The computing device 104 may then evaluate the message payloads in the output queue 106d having the lowest QoS priority value (e.g., level 4, background, low priority). The computing device 104 may determine that a message payload 220 (e.g., a seventh message payload 220) includes a packet having the lowest QoS priority level and the message payload 220 is configured to be sent to the user device 202d. The computing device 104 may determine that the packet within the message payload 220 will fit within the remaining portion of the bandwidth of the channel used by the computing device 104 for sending the packets in the message payload 210. For example, the computing device 104 may determine the data size of the packet in message payload 220 based on the total length field or the total length field and the header length field of the packet. The scheduler 110 or another portion of the computing device 104 may combine the data packets of the message payload 210 and message payload 220 into the multi-device packet (e.g., multi-device packet 226). For example, the scheduler 110 of the computing device 104 may allocate, associate, determine, and/or assign three resource units of the multi-device packet 226 to the message payload 210 (e.g., cause the message payload 210 to use the data space associated with or included within the three resource units), with each resource unit holding one of the three packets 2b. Each of the resource unit (e.g., the first resource unit), the another resource unit (e.g., the second resource unit), and the yet another resource unit (e.g., the third resource unit) may be configured to be sent over a different range of frequencies (e.g., the corresponding frequency allocation, the another frequency allocation, and a yet another frequency allocation) of the bandwidth of the channel. For example, the resource unity, the another resource unit, and the yet another resource unit may be combined into a single resource unit within the multi-device packet 226 to receive all of the message payload 210. For example, the combined resource unit, the another resource unit, and the yet another resource unit may be a single resource unit corresponding to a frequency allocation of the bandwidth of the channel. For example, the computing device 104 may assign an additional resource unit (e.g., the fourth resource unit) of the multi-device packet 226 to the message payload 220 (e.g., cause the message payload 220 to use the data space associated with or included within the additional resource units), with the additional resource unit (e.g., the fourth resource unit) holding the packet 4d of the message payload 220. For example, the additional resource unit (e.g., the fourth resource unit) may be assigned an additional frequency allocation within the bandwidth of the channel (e.g., cause the additional resource unit to be sent within a frequency range in the additional frequency allocation) that is different from the frequency allocation, the another frequency allocation, and the yet another frequency allocation.

The computing device 104 may again determine that no additional packets are in the output queue 106a or waiting to be sent that have the highest QoS priority value. The computing device 104 may again evaluate the output queue 106b for packets having the second highest QoS priority value. The computing device 104 may determine that a message payload 212 (e.g., an eighth message payload 212) includes a plurality of packets having the second highest priority and the message payload 212 is configured to be sent to the user device 202a. The computing device 104 may determine that the plurality of packets within the message payload 212, when sent, would use only a portion of the bandwidth (e.g., a first portion of the bandwidth) of the channel used by the computing device 104 for sending data to other computing devices. Based on the message payload 212 not needing all of the bandwidth of the channel for sending the message payload 212 to the user device 202a, the computing device 104 may evaluate the same output queue 106b for additional packets to combine with the packets of the message payload 212. The computing device 104 may determine that the output queue 106b does not include any additional message payloads or packets waiting to be sent. The computing device 104 may then evaluate the message payloads in the output queue 106c having the third highest QoS priority value. The computing device 104 may determine that there are no packets in the output queue 106c waiting to be sent. The computing device 104 may then evaluate the message payloads in the output queue 106d having the lowest QoS priority value. The computing device 104 may determine that a message payload 218 (e.g., a ninth message payload 218) includes a packet having the lowest QoS priority level and the message payload 218 is configured to be sent to the user device 202c. The computing device 104 may determine that the packet within the message payload 218 will fit within the remaining portion of the bandwidth of the channel used by the computing device 104 for sending the packets in the message payload 212. The scheduler 110 or another portion of the computing device 104 may combine the data packets of the message payload 212 and message payload 218 into the multi-device packet (e.g., multi-device packet 228). For example, the scheduler 110 of the computing device 104 may assign three resource units of the multi-device packet 228 to the message payload 212 (e.g., cause the message payload 212 to use the data space associated with or included within the three resource units), with each resource unit holding one of the three packets 2a. Each of the resource unit (e.g., the first resource unit), the another resource unit (e.g., the second resource unit), and the yet another resource unit (e.g., the third resource unit) may be configured to be sent over a different range of frequencies (e.g., the corresponding frequency allocation, the another frequency allocation, and the yet another frequency allocation) of the bandwidth of the channel. For example, the resource unit, the another resource unit, and the yet another resource unit may be combined into a single resource unit within the multi-device packet 228 to receive all of the message payload 212. For example, the combined resource unit, the another resource unit, and the yet another resource unit may be a single resource unit corresponding to a frequency allocation of the bandwidth of the channel. For example, the computing device 104 may assign an additional resource unit (e.g., the fourth resource unit) of the multi-device packet 228 to the message payload 218 (e.g., cause the message payload 218 to use the data space associated with or included within the additional resource unit), with the additional resource unit (e.g., the fourth resource unit) holding the packet 4c of the message payload 218. For example, the additional resource unit (e.g., the fourth resource unit) may be associated with or assigned an additional frequency allocation within the bandwidth of the channel (e.g., cause the additional resource unit to be sent within a frequency range in the additional frequency allocation) that is different from the frequency allocation, the another frequency allocation, and the yet another frequency allocation.

The multi-device packets 222-228) may be sent by the computing device 104 to the user devices 202a-d via wireless communication. For example, the multi-device packet 222 may be sent from the computing device 104 to the user device 202a via the communication path 222a using the frequency allocation, the another frequency allocation, and the yet another frequency allocation of the bandwidth of the channel, and to the user device 202b via the communication path 222b using the additional frequency allocation of the bandwidth of the channel. For example, the multi-device packet 222 may be sent by the computing device 104 simultaneously or substantially simultaneously to the user device 202a and the user device 202b. For example, the multi-device packet 224 may be sent from the computing device 104 to the user device 202a via the communication path 224a using the frequency allocation and the another frequency allocation of the bandwidth of the channel, and to the third user device 202c via the communication path 224c using the yet another frequency allocation and the additional frequency allocation of the bandwidth of the channel. For example, the multi-device packet 224 may be sent by the computing device 104 simultaneously or substantially simultaneously to the user device 202a and the user device 202c. For example, the multi-device packet 226 may be sent from the computing device 104 to the user device 202b via the communication path 226a using the frequency allocation, the another frequency allocation, and the yet another frequency allocation of the bandwidth of the channel, and to the user device 202d via the communication path 226b using the additional frequency allocation of the bandwidth of the channel. For example, the multi-device packet 226 may be sent by the computing device 104 simultaneously or substantially simultaneously to the user device 202b and the user device 202d. For example, the multi-device packet 228 may be sent from the computing device 104 to the user device 202a via the communication path 228a using the frequency allocation, the another frequency allocation, and the yet another frequency allocation of the bandwidth of the channel, and to the user device 202c via the communication path 228b using the additional frequency allocation of the bandwidth of the channel. For example, the multi-device packet 228 may be sent by the computing device 104 simultaneously or substantially simultaneously to the user device 202a and the user device 202c.

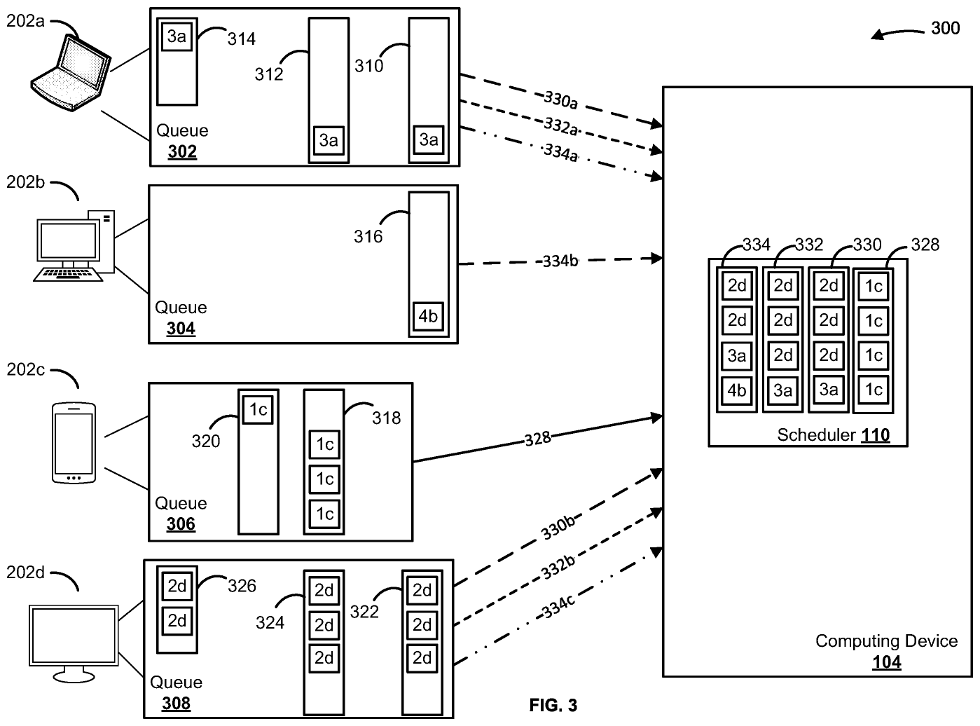

FIG. 3 shows a block diagram for an example system 300 for combining communications to be received by the computing device 104 from to one or more other computing devices (e.g., one or more user devices 202a-d). Although only certain devices and/or components are shown, the system 300 may comprise a variety of other devices and/or components that support a wide variety of network and/or communication functions, operations, protocols, and/or the like. The system 300 may comprise a plurality of computing devices and/or user devices in the network. The network may be a wireless network. Data may be sent on the network via a variety of wireless transmission paths (e.g., satellite paths, Wi-Fi paths, cellular paths, etc.). The network may comprise public networks, private networks, wide area networks (e.g., Internet), local area networks, and/or the like. The network may be configured to provide data for a plurality of user devices 202a-d using a variety of network paths, protocols, devices, and/or the like. The network may deliver data from a plurality of user devices 202a-d to the computing device 104 (e.g., an access point, edge device, network device, router, gateway, etc.).

The system 300 may comprise the computing device 104, which may include the scheduler 110. The scheduler 110 may be a module or software within the computing device 104 that is configured to schedule how packets are received from multiple computing devices (e.g., the user devices 202a-d) by the computing device 104 and how packets are sent by the computing device 104 to the multiple computing device (e.g., the user device 202a-d). The computing device 104 may receive data from one or more of the user devices 202a-d or any other remote computing devices. The data may comprise any form of data, including voice data, video data, audio-video data, network data, application data, etc. The data may be received by the computing device 104 via a wireless network and may be sent by the computing device 104 to one or more other computing devices via a wired or wireless network. For example, the wireless network may be any one of a Wi-Fi, Bluetooth, Bluetooth Low-Energy (BLE), Zigbee, Z-Wave, 6LoWPAN, WiFi Direct, near field communication (NFC), Long Range (LoRa), LoRaWAN, etc.

The system 300 may also comprise one or more user devices (e.g., user devices 202a-d). While the example of FIG. 3 shows four user devices 202a-d, this is for example purposes only, as the system 200 may comprise fewer or greater than four user devices 202a-d. The user devices 202a-d may comprise one or more of a client device, a personal computer, computing station, workstation, portable computer, laptop computer, mobile phone, tablet device, smartphone, smartwatch, activity tracker, smart apparel, smart accessory, security and/or monitoring device, a mobile device, a game system, a content output device, an IoT device, an edge device, an access point, a gateway, a network device, or the like. Each user device 202a-d may be configured to communicate via a wireless communication protocol with the computing device 104. For example, each user device 202a-d may be configured to communicate with the computing device 104 via the Wi-Fi 6 (802.11ax) wireless protocol.

The computing device 104 may be configured to receive packets having different QoS priority levels from a plurality of user devices 202a-d via a wireless network. The scheduler 110 or another portion of the computing device 104 may be configured to partition the bandwidth of the channel on which the computing device 104 is receiving data from the user devices 202a-d, in order to permit multiple user devices 202a-d to send data for receipt by the computing device 104 at the same time and/or to permit the user device to send two separate message payloads having a QoS service level higher than best efforts, normal, level 3 priority from the same user device 202a-d.

The computing device 104 may determine the QoS priority level associated with or assigned to each packet waiting to be sent by the user devices 202a-d to the computing device 104. For example, each user device 202a-d may send a message that may be received by the computing device 104. The message may comprise a buffer status report for that particular user device 202a-d. The message may indicate the packets the particular user device 202a-d has buffered and that are waiting to be sent to the computing device 104. For example, the message may indicate the quantity of packets and/or amount of data in each message payload (e.g., message payloads 310-322 of FIG. 3). For example, the message may indicate the QoS priority level for each packet or message payload 310-322. For example, the message may be received from each user device 202a-d based on the computing device 104 sending a buffer status report trigger frame to that particular user device 202a-d.

For example, the message from the user device 202a may indicate that the user device 202a is waiting to send a message payload 310 (e.g., a first message payload 310) having a packet with the third highest QoS priority level, a message payload 312 (e.g., a second message payload 312) having a packet with the third highest QoS priority level, and a message payload 314 (e.g., a third message payload 314) having a packet with the third highest QoS priority level. For example, the message from the user device 202b may indicate that the user device 202b is waiting to send a message payload 316 (e.g., a fourth message payload 316) having a packet with the lowest QoS priority level. For example, a message from the user device 202c may indicate that the user device 202c is waiting to send a message payload 318 (e.g., a fifth message payload 318) having three packets with the highest QoS priority level and a message payload 320 (e.g., a sixth message payload 320) having a packet with the highest QoS priority level. For example, a message from the user device 202d may indicate that the user device 202d is waiting to send a message payload 322 (e.g., a seventh message payload 322) having three packets with the second highest QoS priority level, a message payload 324 (e.g., an eighth message payload 324) having three packets with the second highest QoS priority level, and a message payload 326 (e.g., a ninth message payload 326) having two packets with the second highest QoS priority level. Each message may also indicate the order in which the particular user device 202a-d intends to send each message payload. The computing device 104 may provide the information from the messages to the scheduler 110 to schedule when each user device 202a-d will send its data to the computing device 104.

For example, the scheduler 110 or another portion of the computing device 104 may determine how to partition the bandwidth of the channel on which the computing device 104 is receiving the data from the user devices 202a-d to have multiple message payloads sent to the computing device 104 by one or more user devices 202a-d at the same time. For example, the scheduler 110 may evaluate the user devices 202a-d in QoS priority level order, from highest priority level to lowest priority level. For example, the user devices 202a-d may be associated with or assigned a particular QoS priority level at which all of its packets will be sent to the computing device 104. The QoS priority level for the user device 202a-d may be static (e.g., the particular user device always has the particular QoS priority level) or dynamic (e.g., the QoS priority level for the particular user device may change over time) based on the types of data it is communicating. For example, the user device 202c may be associated with or assigned the highest QoS priority level, the user device 202d may be associated with or assigned the second highest QoS priority level, the user device 202a may be associated with or assigned the third highest QoS priority level, and the user device 202b may be associated with or assigned the lowest QoS priority level. While not shown, in other examples, multiple user devices 202a-d may be associated with or assigned the same QoS priority level (e.g., multiple user devices being assigned the highest QoS priority level).

For example, the computing device 104 may determine the message payload 318 in the output queue 306 for the user device 202c includes a plurality of packets having a highest priority (e.g., priority level 1, voice, or high) and the message payload 318 is configured to be sent to the computing device 104. The computing device 104 may determine that the three packets (e.g., data) within the message payload 318, when sent, would use only a portion of the bandwidth (e.g., a first portion of the bandwidth) of the channel for the computing device 104 to receive the three packets in the message payload 318.

For example, the computing device 104 may evaluate the total length field of the packets that make up the message payload 318 to determine the total number of bytes within each of the packets. For example, the computing device 104 may determine the total number of bytes within each of the packets of the message payload 318, based on the sum of the total length field of each packet, as the size of the packets within the message payload 318 and may compare that amount to the amount of data space available in the bandwidth of the channel used by the computing device 104 for sending data to other computing devices. For example, the computing device 104 may evaluate the total length field of each of the packets that make up the message payload 318 to determine the total number of bytes within the each packet. The computing device 104 may then subtract the number of 32-bit words that make up the header (e.g., provided in the header length field of each packet) to determine the size of each packet that makes up the message payload 318. The computing device 104 may then sum the packet sizes or determine the entire payload size and compare the determined size of the message payload 318 (e.g., based on the combined size or sum of each packet within the payload 318) to the amount of data space available in the bandwidth of the channel used by the computing device 104 for sending data to other computing devices.

Based on the message payload 318 not needing all of the bandwidth of the channel for the computing device 104 to receive the message payload 318 from the user device 202c, the computing device 104 may evaluate the buffer status report for the same user device 202c, or any other packets or message payloads having the same highest QoS priority level in other user devices 202a-d, for other data (e.g., message payloads) to combine or associate with the three packets of the message payload 318 for sending at the same time to the computing device 104 within the remaining portion of the bandwidth of the channel. For example, the computing device 104 may determine the packet in the message payload 320 has the same QoS priority level as the message payload 318, and is of a data size that it would use (e.g., could be sent within) a second portion (e.g., a remaining portion) of the bandwidth of the channel when received by the computing device 104. While the example, shows both the message payload 318 and the message payload 320 being sent from the same user device (e.g., the user device 202c), this is for example purposes only. In other examples, the message payload 318 may be sent from the user device 202c and the message payload 320 may be sent from another user device. The process may continue in substantially the same manner until a sufficient number of packets are obtained from the plurality of message payloads having the first QoS priority level (or lower QoS priority levels if a sufficient amount of data having the first QoS priority level is not buffered at the user devices 202a-d to send to the computing device 104) to use a predetermined amount of the bandwidth of the channel for simultaneous sending by the user devices to the computing device 104. The scheduler 110 or another portion of the computing device 104 may generate and send a message to the user device 202c. For example, the message may indicate a first time for both the message payload 318 and the message payload 320 to be sent to the computing device 104. For example, the message may indicate a portion of the bandwidth (e.g. a first portion of the bandwidth) of the channel to send the packets in the message payload 318 and another portion of the bandwidth (e.g., a second portion of the bandwidth) of the channel to send the packet of the message payload 320. For example, the message may indicate a single frequency allocation for sending the multiple packets of the message payload 318 or may indicate a frequency allocation (e.g., the first frequency allocation), another frequency allocation (e.g., the second frequency allocation), and a yet another frequency allocation (e.g., the third frequency allocation) of the bandwidth of the channel to send the corresponding three packets of the message payload 318 and an additional frequency allocation (e.g., the fourth frequency allocation which corresponds to the another portion of the bandwidth) of the bandwidth of the channel to send the packet of the message payload 320. The user device 202c may send the packets of the message payload 318 to the computing device 104 via the communication pathway 328 at the first time using the portion of the bandwidth of the channel (e.g., the frequency allocation, the another frequency allocation, and the yet another frequency allocation). The user device 202c (or another user device in other examples) may send the packet of the message payload 320 to the computing device 104 via the communication pathway 328 also at the first time using the another portion of the bandwidth of the channel (e.g., the additional frequency allocation). The computing device 104 may receive the packets of the message payload 318 via the portion of the bandwidth of the channel and the packet of the message payload 320 via the another portion of the bandwidth at the same time or substantially the same time in the form of the multi-device packet 328.

The scheduler 110 or another portion of the computing device 104 may evaluate the buffer status reports of the user devices 202a-d to determine or schedule the next communications to be received by the computing device 104. The computing device 104 may determine, based on the buffer status reports, that no additional packets are waiting to be sent from the user device (e.g., user device 202c) having the highest QoS priority level to the computing device and no other packets having the highest QoS priority level are waiting to be sent from other user devices to the computing device 104. For example, the computing device 104 may then evaluate the buffer status reports for user devices or packets associated with or assigned the second highest QoS priority level waiting to be sent to the computing device 104. For example, the computing device 104 may determine the message payload 322 in the output queue 308 for the user device 202c includes a plurality of packets having the second highest priority and the message payload 322 is configured to be sent to the computing device 104. The computing device 104 may determine that the three packets (e.g., data) within the message payload 322, when sent, would use only a portion of the bandwidth (e.g., a first portion of the bandwidth) of the channel for the computing device 104 to receive the three packets in the message payload 322.

Based on the message payload 322 not needing all of the bandwidth of the channel for the computing device 104 to receive the message payload 322 from the user device 202d, the computing device 104 may evaluate the buffer status report for the same user device 202d, or any other packets or message payloads having the second highest QoS priority level in other user devices 202a-d, for other data (e.g., message payloads) to combine or associate with the three packets of the message payload 322 for sending at the same time to the computing device 104 within the remaining portion of the bandwidth of the channel. For example, the computing device 104 may determine, based on the buffer status report for the fourth computing device 202d, that the queue 308 includes two additional message payloads 324, 326, that have the second highest QoS priority value, but that each message payload 324, 326 includes too much data (or too many additional packets) based on the remaining portion of the bandwidth of the channel to be sent at the same time as the message payload 322. The computing device 104 may then evaluate the buffer status reports for user devices or packets associated with or assigned the third highest QoS priority level waiting to be sent to the computing device 104. For example, the computing device 104 may evaluate the buffer status report for the user device 202a. For example, the computing device 104 may determine the packet in the message payload 310 is of a data size that it would use (e.g., could be sent within) the second portion (e.g., the remaining portion) of the bandwidth of the channel when received by the computing device 104. The process may continue in substantially the same manner until a sufficient number of packets are obtained from the plurality of message payloads having the second QoS priority level (or lower QoS priority levels if a sufficient amount of data having the second QoS priority level is not buffered at the user devices 202a-d to send to the computing device 104) to use a predetermined amount of the bandwidth of the channel for simultaneous sending by the user devices to the computing device 104. The scheduler 110 or another portion of the computing device 104 may generate and send a message to the user device 202a and the user device 202d. For example, the message may indicate a second time for both the user device 202a to send the packet in the message payload 310 and the user device 202d to send the packets in the message payload 322 to the computing device 104. For example, the message may indicate a portion of the bandwidth (e.g., the first portion of the bandwidth) of the channel to be used by the user device 202d to send the packets in the message payload 322 and another portion (e.g., the second portion) of the bandwidth of the channel to be used by the user device 202a to send the packet of the message payload 310. For example, the message may indicate a single frequency allocation for sending the multiple packets of the message payload 322 or may indicate a frequency allocation, another frequency allocation, and a yet another frequency allocation of the bandwidth of the channel to send the corresponding three packets of the message payload 322 and an additional frequency allocation (corresponding to the another portion of the bandwidth) of the bandwidth of the channel to send the packet of the message payload 310. The user device 202d may send the packets of the message payload 322 to the computing device 104 via the communication pathway 330b at the second time using the portion of the bandwidth of the channel (e.g., the frequency allocation, the another frequency allocation, and the yet another frequency allocation). The user device 202a may send the packet of the message payload 310 to the computing device 104 via the communication pathway 330a also at the second time using the another portion of the bandwidth of the channel (e.g., the additional frequency allocation). The computing device 104 may receive the packets of the message payload 322 via the portion of the bandwidth of the channel and the packet of the message payload 310 via the another portion of the bandwidth at the same time or substantially the same time in the form of the multi-device packet 330.

The scheduler 110 or another portion of the computing device 104 may evaluate the buffer status reports of the user devices 202a-d to determine or schedule the next communications to be received by the computing device 104. The computing device 104 may determine, based on the buffer status reports, that no additional packets are waiting to be sent from the user device (e.g., user device 202c) having the highest QoS priority level to the computing device and no other packets having the highest QoS priority level are waiting to be sent from other user devices to the computing device 104. For example, the computing device 104 may then evaluate the buffer status reports for user devices or packets associated with or assigned the second highest QoS priority level waiting to be sent to the computing device 104. For example, the computing device 104 may determine the message payload 324 in the output queue 308 for the user device 202c includes a plurality of packets having the second highest QoS priority level and the message payload 324 is configured to be sent to the computing device 104. The computing device 104 may determine that the three packets (e.g., data) within the message payload 324, when sent, would use only the portion of the bandwidth of the channel for the computing device 104 to receive the three packets in the message payload 324.

Based on the message payload 324 not needing all of the bandwidth of the channel for the computing device 104 to receive the message payload 324 from the user device 202d, the computing device 104 may evaluate the buffer status report for the same user device 202d, or any other packets or message payloads having the second highest QoS priority level in other user devices 202a-d, for other data (e.g., message payloads) to combine or associate with the three packets of the message payload 324 for sending at the same time to the computing device 104 within the remaining portion of the bandwidth of the channel. For example, the computing device 104 may determine, based on the buffer status report for the fourth computing device 202d, that the queue 308 includes an additional message payload 326, that has the second highest QoS priority value, but that the message payload 326 includes too much data (or too many additional packets) based on the remaining portion of the bandwidth of the channel, to be sent at the same time as the message payload 324. The computing device 104 may then evaluate the buffer status reports for user devices or packets associated with or assigned the third highest QoS priority level waiting to be sent to the computing device 104. For example, the computing device 104 may evaluate the buffer status report for the user device 202a. For example, the computing device 104 may determine the packet in the message payload 312 is of a data size that it would use (e.g., could be sent within) the second portion (e.g., the remaining portion) of the bandwidth of the channel when received by the computing device 104. The process may continue in substantially the same manner until a sufficient number of packets are obtained from the plurality of message payloads having the second QoS priority level (or lower QoS priority levels if a sufficient amount of data having the second QoS priority level is not buffered at the user devices 202a-d to send to the computing device 104) to use a predetermined amount of the bandwidth of the channel for simultaneous sending by the user devices to the computing device 104. The scheduler 110 or another portion of the computing device 104 may generate and send a message to the user device 202a and the user device 202d. For example, the message may indicate a third time for both the user device 202a to send the packet in the message payload 312 and the user device 202d to send the packets in the message payload 324 to the computing device 104. For example, the message may indicate the portion of the bandwidth (e.g., the first portion of the bandwidth) of the channel to be used by the user device 202d to send the packets in the message payload 324 and another portion (e.g., the second portion) of the bandwidth of the channel to be used by the user device 202a to send the packet of the message payload 312. For example, the message may indicate a single frequency allocation for sending the multiple packets of the message payload 324 or may indicate a frequency allocation, another frequency allocation, and a yet another frequency allocation of the bandwidth of the channel to send the corresponding three packets of the message payload 324 and an additional frequency allocation (corresponding to the another portion of the bandwidth) of the bandwidth of the channel to send the packet of the message payload 312. The user device 202d may send the packets of the message payload 324 to the computing device 104 via the communication pathway 332b at the third time using the portion of the bandwidth of the channel (e.g., the frequency allocation, the another frequency allocation, and the yet another frequency allocation). The user device 202a may send the packet of the message payload 312 to the computing device 104 via the communication pathway 332a, also at the third time, using the another portion of the bandwidth of the channel (e.g., the additional frequency allocation). The computing device 104 may receive the packets of the message payload 324 via the portion of the bandwidth of the channel and the packet of the message payload 312 via the another portion of the bandwidth at the same time or substantially the same time in the form of the multi-device packet 332.

The scheduler 110 or another portion of the computing device 104 may evaluate the buffer status reports of the user devices 202a-d to determine or schedule the next communications to be received by the computing device 104. The computing device 104 may determine, based on the buffer status reports, that no additional packets are waiting to be sent from the user device (e.g., user device 202c) having the highest QoS priority level to the computing device and no other packets having the highest QoS priority level are waiting to be sent from other user devices to the computing device 104. For example, the computing device 104 may then evaluate the buffer status reports for user devices or packets associated with or assigned the second highest QoS priority level waiting to be sent to the computing device 104. For example, the computing device 104 may determine the message payload 326 in the output queue 308 for the user device 202c includes a plurality of packets having the second highest QoS priority level and the message payload 326 is configured to be sent to the computing device 104. The computing device 104 may determine that the two packets (e.g., data) within the message payload 326, when sent, would use only the portion of the bandwidth of the channel for the computing device 104 to receive the two packets in the message payload 326.

Based on the message payload 326 not needing all of the bandwidth of the channel for the computing device 104 to receive the message payload 326 from the user device 202d, the computing device 104 may evaluate the buffer status report for the same user device 202d, or any other packets or message payloads having the second highest QoS priority level in other user devices 202a-d, for other data (e.g., message payloads) to combine or associate with the two packets of the message payload 326 for sending at the same time to the computing device 104 within another portion of the bandwidth of the channel. For example, the computing device 104 may determine, based on the buffer status reports, that no additional packets are waiting to be sent from the user device 202d having the second highest QoS priority level to the computing device 104 and no other packets having the second highest QoS priority level are waiting to be sent from other user devices to the computing device 104. The computing device 104 may then evaluate the buffer status reports for user devices or packets associated with or assigned the third highest QoS priority level waiting to be sent to the computing device 104. For example, the computing device 104 may evaluate the buffer status report for the user device 202a and determine the packet in the message payload 314 in the queue 302 is of a data size that it would use (e.g., could be sent within) another portion (e.g., the second portion) of the bandwidth of the channel when received by the computing device 104.

Based on the message payload 326 and message payload 314 not needing all of the bandwidth of the channel for the computing device 104 to receive the message payload 326 from the user device 202d and the message payload 314 from the user device 202a, the computing device 104 may evaluate the buffer status report for the same user device 202a, or any other packets or message payloads having the third highest QoS priority level in other user devices 202a-d, for other data (e.g., message payloads) to combine or associate with the two packets of the message payload 326 and the packet of the message payload 314 for sending at the same time to the computing device 104 within yet another portion (e.g., a third portion) of the bandwidth of the channel. For example, the computing device 104 may determine, based on the buffer status reports, that no additional packets are waiting to be sent from the user device 202a having the third highest QoS priority level to the computing device 104 and no other packets having the third highest QoS priority level are waiting to be sent from other user devices to the computing device 104. The computing device 104 may then evaluate the buffer status reports for user devices or packets associated with or assigned the lowest QoS priority level waiting to be sent to the computing device 104. For example, the computing device 104 may evaluate the buffer status report for the user device 202b and determine the packet in the message payload 316 in the queue 304 is of a data size that it would use (e.g., could be sent within) the yet another portion of the bandwidth of the channel when received by the computing device 104. The process may continue in substantially the same manner until a sufficient number of packets are obtained from the plurality of message payloads having the second, third, or lowest QoS priority levels to use a predetermined amount of the bandwidth of the channel for simultaneous sending by the user devices to the computing device 104. The scheduler 110 or another portion of the computing device 104 may generate and send a message to the user device 202a, the user device 202b, and the user device 202d. For example, the message may indicate a fourth time for each of the user device 202a to send the packet in the message payload 314, the user device 202b to send the packet in the message payload 316, and the user device 202d to send the packets in the message payload 326 to the computing device 104. For example, the message may indicate the portion (e.g., the first portion) of the bandwidth of the channel to be used by the user device 202d to send the packets in the message payload 326, another portion (e.g., the second portion) of the bandwidth of the channel to be used by the user device 202a to send the packet of the message payload 314, and yet another portion (e.g., the third portion) of the bandwidth of the channel to be used by the user device 202b to send the packet of the message payload 316.

For example, the message may indicate a single frequency allocation for sending the multiple packets of the message payload 326 or may indicate a frequency allocation and another frequency allocation of the bandwidth of the channel to send the corresponding two packets of the message payload 326, a yet another frequency allocation (corresponding to the another portion of the bandwidth) of the bandwidth of the channel to send the packet of the message payload 314, and an additional frequency allocation (corresponding to the yet another portion of the bandwidth) of the bandwidth of the channel to send the packet of the message payload 316. The user device 202d may send the packets of the message payload 326 to the computing device 104 via the communication pathway 334c at the fourth time using the portion of the bandwidth of the channel (e.g., the frequency allocation and the another frequency allocation). The user device 202a may send the packet of the message payload 314 to the computing device 104 via the communication pathway 334a, also at the fourth time, using the another portion of the bandwidth of the channel (e.g., the yet another frequency allocation). The user device 202b may send the packet of the message payload 316 to the computing device 104 via the communication pathway 334b, also at the fourth time, using the yet another portion of the bandwidth of the channel (e.g., the additional frequency allocation). The computing device 104 may receive the packets of the message payload 326 via the portion of the bandwidth of the channel, the packet of the message payload 314 via the another portion of the bandwidth, and the packet of the message payload 316 via the yet another portion of the bandwidth at the same time or substantially the same time in the form of the multi-device packet 334.

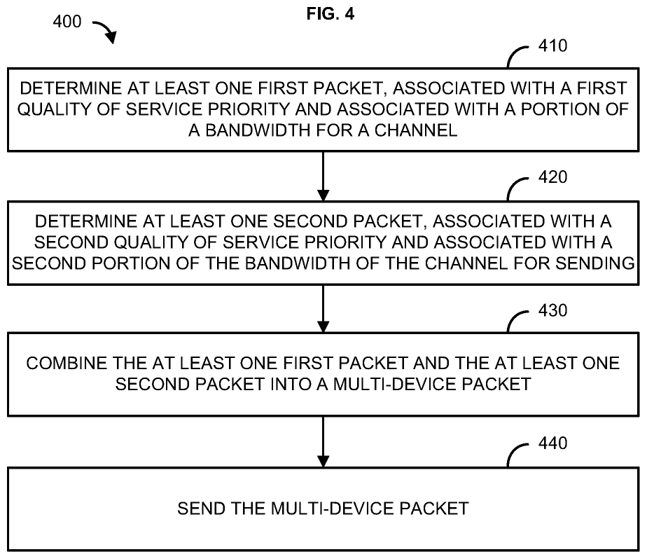

FIG. 4 is a flowchart showing an example method 400 for managing wireless communications to one or more other computing devices (e.g., user devices 102a-d, 202a-d). The method 400 may be completed by a computing device (e.g., the computing device 104, the gateway 114, or any other computing device). Further, the method 400 describes example communications between computing devices. While the example communications show direct communications between one computing device and another computing device, this is for example purposes only, as networks (e.g., network 116) or other computing devices not shown, may be intermediary devices along a communication path between one or more of the communications between the computing devices shown.

The computing device 104 may receive or generate a packet or message payload comprising a plurality of packets. The packet or message payload comprising the plurality of packets may be received from any computing device (e.g., the user devices 102a-d, 202a-d, the gateway 114, the computing device 118 or any other computing device).

The computing device 104 may determine the QoS priority level associated with or assigned to or associated with each packet of the plurality of packets. For example, the classifier 108, or any other portion, of the computing device 104 may check the access categories 112 to determine what QoS priority level to assign to or associate with each packet of the plurality of packets. For example, the classifier 108, or any other portion, of the computing device 104 may use network-based application recognition (NBAR) to determine what QoS priority level to assign to or associate with each packet of the plurality of packets.

For example, the computing device 104 may assign or associate the QoS priority level to each packet of the plurality of packets. For example, the classifier 108, or any other portion, of the computing device 104 may insert an indication of the assigned or associated QoS priority level into each packet of the plurality of packets. For example, the classifier 108 may insert the indication into a “type of service” field or another field of the IP header of each packet of the plurality of packets. For example, the classifier 108, or any other portion, of the computing device 104 may use differentiated services code point (DSCP) to insert the indication of the associated or assigned QoS priority level into each packet of the plurality of packets.

For example, one or more of the plurality of packets may have previously been assigned or associated with the QoS priority level (e.g., by another computing device and/or prior to being received by the computing device 104). For example, the computing device 104 may evaluate each of these packets to identify the indicator of the assigned or associated QoS priority level and determine, based on the indicator, the assigned or associated QoS priority level. For example, the computing device 104 may determine the assigned or associated QoS priority level of each packet by evaluating one or more fields (e.g., the type of service field in the IP header) of the packet.

The computing device 104 may place each packet of the plurality of packets into a queue. For example, the queue may be memory or another storage area with the computing device 104 where the packets may be placed until they are packaged and sent from the computing device 104 to another computing device. For example, the computing device 104 may include a plurality of queues (e.g., the output queues 106a-d). For example, the computing device 104 may include a separate queue for packets associated with each QoS priority level. For example, the computing device 104 may store each packet in a queue that corresponds with the QoS priority level assigned to or associated with the individual packet. For example, the output queue 106a may be configured as a queue for packets assigned to or associated with a highest QoS priority level. For example, the highest QoS priority level may be voice or high priority. For example, the output queue 106b may be configured as a queue for packets assigned to or associated with a second highest QoS priority level. For example, the second highest QoS priority level may be video or medium priority. For example, the output queue 106c may be configured as a queue for packets assigned to or associated with a third highest QoS priority level. For example, the third highest QoS priority level may be best efforts or normal priority. For example, the output queue 106d may be configured as a queue for packets assigned to or associated with the lowest QoS priority level. For example, the lowest QoS priority level may be background or low priority. For example, the computing device 104 may prioritize sending packets having higher priority over those having lower priority. For example, the computing device 104 may include mechanisms (e.g., timers, data caps, etc.) to limit the amount of higher priority packets that are sent before lower priority packets are sent.

For example, the computing device 104 may store a portion of the plurality of the packets in one or more message payloads (e.g., message payloads 204-220) within the queue 106a-d that the packet was assigned or associated with. For example, each message payload may include one or a plurality of packets. For example, each message payload may be constructed to be sent by the computing device 104 to a single other computing device (e.g., user devices 102a-d, 202a-d).

At 410, at least one first packet, to be sent or transmitted, may be determined. For example, the at least one first packet may be determined by the scheduler 110 of the computing device 104. For example, the computing device 104 may determine that the at least one first packet is to be wirelessly transmitted by the computing device 104. For example, the at least one first packet may have or be associated with a first QoS priority level. For example, the first QoS priority level may be a higher priority than a second QoS priority level. For example, the first QoS priority level may be one of voice priority, video priority, high priority or medium priority. For example, the first QoS priority level may be any priority level higher than best efforts priority level and/or normal priority level.

For example, the computing device 104 may determine the at least one first packet to be sent by evaluating the output queues 106a-d of the computing device 104. For example, the computing device 104 may evaluate the output queues 106a-d for packets to be sent, in priority level order, from highest QoS priority level queue to lowest QoS priority level queue. For example, the computing device 104 may first evaluate the output queue 106a based on it storing packets associated with or assigned the highest QoS priority level. The computing device 104 may next evaluate the output queue 106b based on it storing packets associated with or assigned the second highest QoS priority level. The computing device 104 may next evaluate the output queue 106c based on it storing packets associated with or assigned the third highest QoS priority level. The computing device 104 may next evaluate the output queue 106d based on it storing packets associated with or assigned the lowest QoS priority level.

For example, the computing device 104 may determine or identify one or more message payloads 204-220 in the output queues 106a-d. Each of the message payloads 204-220 may include one or more packets or groups of packets. The packets and the message payloads comprising the packets may be stored in their respective output queues 106a-d in chronological order and optionally configured to be sent by the computing device 104 to one or more other computing devices in a first-in, first out (FIFO) order.

For example, the computing device 104 may evaluate the output queue 106a and determine that no message payloads or packets are waiting to be sent. The computing device may then evaluate the output queue 106b and determine that one or more message payloads and/or packets have been placed in the queue 106b to be sent. For example, the computing device 104 may determine a message payload 208 (e.g., the first message payload 208 in the output queue 106b) includes one or a plurality of packets assigned or associated with a second highest QoS priority (e.g., priority level 2, video, or medium) and the message payload is configured to be sent to user device 202c. For example, the computing device 104 may determine the message payload 208 includes the at least one first packet that is a next packet assigned or associated with the first QoS priority level to be sent by the computing device 104. Further, based on the first QoS priority level being the highest QoS priority level for which packets (in message payloads) are waiting to be sent, the computing device 104 may determine that the at least one first packet within the message payload 208 will be at least part of the next packet to be sent by the computing device 104. For example, the computing device 104 may determine that the at least one first packet (e.g., data) is associated with a portion of bandwidth for a channel. For example, the computing device 104 may determine the at least one first packet within the message payload 208, when sent, would use only the portion of the bandwidth of the channel used by the computing device 104 for sending data to other computing devices.

For example, the computing device 104 may evaluate the total length field of the packet or packets that make up the message payload 208 to determine the total number of bytes within the packet. For example, the computing device 104 may determine the total number of bytes within the packet or packets of the message payload 208, based on the total length field of each packet, as the size of the packet or packets within the message payload 208. The computing device 104 may compare that amount to the amount of data space available in the bandwidth of the channel used by the computing device 104 for sending data to other computing devices. For example, the computing device 104 may evaluate the total length field of the packet or packets that make up the message payload 208 to determine the total number of bytes within the packet. The computing device 104 may then subtract the number of 32-bit words that make up the header (e.g., provided in the header length field of each packet) to determine the size of each packet that makes up the message payload 208. The computing device 104 may then compare the determined size of the message payload 208 (e.g., based on the combined size or sum of each packet within the payload 208) to the amount of data space available in the bandwidth of the channel used by the computing device 104 for sending data to other computing devices.

Based on the message payload 208 not needing all of the bandwidth of the channel for sending the message payload to user device 202c, the computing device 104 may determine that the one or more packets making up the message payload 208 are associated with or would only use the portion (e.g., first portion) of the bandwidth of the channel and that other portions of the bandwidth of the channel may be available to send additional packet(s) to the same or other computing devices. The computing device 104 may evaluate the same output queue 106b, or any other packets or message payloads having the same QoS priority level, for other data (e.g., message payloads) to combine with the message payload 208 for sending at the same time within the bandwidth of the channel. For example, the computing device 104 may determine that there are no additional message payloads or packets having the same QoS priority level as the message payload 208. For example, the computing device 104 may determine that additional message payloads (e.g., message payloads 210, 212) include packets having the same priority as the packets in the message payload 208. The computing device 104 may determine that each of the additional message payloads include too much data (e.g., within the packets) to fit within the remaining portion of the bandwidth of the channel used by the computing device 104 for sending data. For example, the computing device 104 may determine that neither of the additional message payloads 210, 212 may be combined with the message payload 208 to be sent at the same time by the computing device 104 within the bandwidth of the channel used by the computing device 104 for sending data to other computing devices. Based on the computing device 104 determining that no message payloads or packets having the same QoS priority level can be combined with the data of the message payload in the queue, the computing device 104 may determine if message payloads or packets assigned or associated with a different QoS priority level than that of the message payload 208 can be combined with the message payload 208 to be sent at the same time as the message payload 208 and within another portion (e.g., a second portion or a third portion) of the bandwidth of the channel used by the computing device 104.

At 420, at least one second packet to be sent or transmitted, may be determined. For example, the at least one second packet may be determined by the scheduler 110 of the computing device 104. For example, the at least one second packet may be determined based on the at least one first packet determined to need only the portion of bandwidth of the channel to be sent at a particular time. For example, the computing device 104 may determine that the at least one second packet is to be wirelessly transmitted by the computing device 104. For example, the at least one second packet may be assigned or associated with the second QoS priority level, different from the first QoS priority level. For example, the second QoS priority level may be a lower priority level than the first QoS priority level. For example, the second QoS priority may be one of video priority, best efforts priority, or background priority. For example, the second QoS priority level may be one of medium priority, normal priority, or low priority. For example, the second QoS priority level may be any priority level lower than the highest QoS priority level.

For example, the computing device 104 may determine that the at least one second packet is associated with another portion (e.g., a second portion) of the bandwidth of the channel for sending. For example, the computing device 104 may determine the at least one second packet would use or could fit within the another portion of the bandwidth of the channel for sending at the particular time. For example, the destination for the at least one first packet and the at least one second packet may be the same or different. For example, the destination for the at least one first packet may be a computing device (e.g., user device 202c) and the destination for the at least one second packet may be the same or another computing device (e.g., user device 202a).

For example, the computing device 104 may determine the at least one second packet to be sent by evaluating the lower QoS priority output queues (e.g., the output queues 106c-d due to the at least one first packet of 410 being from the output queue 106b) of the computing device 104 for message payloads comprising one or more packets that would fit within the remaining portion of the bandwidth of the channel used by the computing device 104. For example, the computing device 104 may evaluate the output queues for packets to be sent, in priority level order, from highest QoS priority level queue to lowest QoS priority level queue for message payloads comprising one or more packets that would fit within the remaining or another portion of the bandwidth of the channel for sending at the particular time. For example, based on it storing packets associated with or assigned the next highest QoS priority level as that of the output queue 106b, the computing device 104 may first evaluate the output queue 106c for message payloads comprising one or more packets that would fit within the remaining portion of the bandwidth of the channel. The computing device 104 may optionally evaluate the output queue 106d for message payloads comprising one or more packets that would fit within the remaining portion of the bandwidth of the channel, based on the output queue 106d storing packets associated with or assigned the lowest QoS priority level, if no message payloads or packets are determined in the output queue 106c that would fit within the remaining portion of the bandwidth of the channel.

For example, the computing device 104 may determine the at least one second packet in message payload 214 of the output queue 106c. For example, the computing device 104 may determine the at least one second packet in the message payload 214 is assigned or associated with the QoS priority level of level 3, best efforts, or normal, and that the destination of the at least one second packet is user device 202a. For example, the computing device 104 may determine the QoS priority level for the at least one second packet based on the queue the packet is in or based on an evaluation of a field within a header of the packet (e.g., the type of service field of the IP header). For example, the computing device 104 may determine that the at least one second packet (e.g., packet 3a) in message payload 214 is associated with the another portion of the bandwidth of the channel for sending at the particular time. For example, the computing device 104 may determine that the at least one second packet in message payload 214 is of a data size that it would use (e.g., could be sent within) or fit within the another portion of the bandwidth of the channel for sending at the particular time. For example, the computing device 104 may determine the data size of the second packet (e.g., packet 3a) in message payload 214 based on the total length field or the total length field and the header length field of the second packet.

For example, the computing device 104 may determine that the combination of the at least one first packet of the message payload 208 and the at least one second packet of the message payload 214 have a combined size (amount of data) that would only use yet another portion (e.g., a third portion) of the bandwidth of the channel, wherein the third portion is greater than the portion of the bandwidth and the another portion of the bandwidth and wherein the bandwidth of the channel includes an additional portion (e.g., a fourth portion) of the bandwidth of the channel. For example, the computing device 104 may determine at least one third packet to be sent. For example, the at least one third packet may be determined based on the at least one first packet associated with the portion of the bandwidth and the at least one second packet associated with the another portion of the bandwidth of the channel being determined to need only the third portion of bandwidth of the channel to be sent at the particular time. For example, the computing device 104 may determine that the at least one third packet is to be wirelessly transmitted by the computing device 104. For example, the at least one third packet may be assigned or associated with the second QoS priority level or a third QoS priority level, different from the first QoS priority level and the second QoS priority level. For example, the third QoS priority level may be a lower priority level than the second QoS priority level. For example, the third QoS priority may be one of best efforts priority, or background priority. For example, the third QoS priority level may be one of normal priority, or low priority. For example, the third QoS priority level may be any priority level lower than the second QoS priority level.

For example, the computing device 104 may determine that the at least one third packet is associated with the additional portion (e.g., the fourth portion) of the bandwidth of the channel for sending at the particular time. For example, the computing device 104 may determine that the at least one third packet would use (or fit with) a fourth portion (e.g., remaining portion) of the bandwidth of the channel for sending at the particular time. For example, the destination for the at least one first packet, the at least one second packet, and the at least one third packet may be the same or different. For example, the destination for the at least one first packet may be a computing device (e.g., user device 202c) and the destination for the at least one second packet and third packet may be the same or another second computing device (e.g., user device 202a).

For example, the computing device 104 may determine the at least one third packet to be sent by evaluating the output queue of the at least one second packet (e.g., output queue 106c) and any lower QoS priority output queues (e.g., the output queue 106d) of the computing device 104 for message payloads comprising one or more packets that may be associated with (e.g., would fit within) the additional or remaining portion of the bandwidth of the channel used by the computing device 104 for simultaneous sending at the particular time. For example, the computing device 104 may first evaluate the output queue 106c for message payloads comprising one or more packets that would fit within the remaining portion of the bandwidth of the channel. Based on determining no message payloads or packets are in the output queue 106c that would fit within the remaining portion of the bandwidth of the channel, the computing device 104 may optionally evaluate the output queue 106d for message payloads comprising one or more packets that would fit within the remaining portion of the bandwidth of the channel for sending at the particular time. The process may continue in substantially the same manner until a sufficient number of packets are obtained from the plurality of message payloads to use a predetermined amount of the bandwidth of the channel for simultaneous sending to other computing devices by the computing device 104 at the particular time.

For example, the computing device 104 may determine the at least one third packet in message payload 216 of the output queue 106c. For example, the computing device 104 may determine the at least one third packet in the message payload 216 is assigned or associated with the QoS priority level of level 3, best efforts, or normal and that the destination of the at least one third packet is user device 202a. For example, the computing device 104 may determine the QoS priority level for the at least one third packet based on the queue the packet is in or based on an evaluation of a field within a header of the packet (e.g., the type of service field of the IP header). For example, the computing device 104 may determine that the at least one third packet (e.g., packet 3a) in message payload 216 is of a data size that it is associated with (e.g., would use, could be sent within, or fit within) the additional portion of the bandwidth of the channel for sending by the computing device 104 at the particular time. For example, the computing device 104 may determine the data size of the third packet (e.g., packet 3a) in message payload 216 based on the total length field or the total length field and the header length field of the second packet.

At 430, the at least one first packet and the at least one second packet may be combined into the multi-device packet (e.g., multi-device packet 224). For example, the packets may be combined into the multi-device packet by the scheduler 110 of the computing device 104. For example, the computing device 104 may combine the at least one first packet (from message payload 208), the at least one second packet (from message payload 214), and the at least one third packet (from message payload 216) into the multi-device packet 224.

For example, the computing device 104 may generate or determine the multi-device packet 224. The multi-device packet 224 may be divided into a plurality of resource units. Each of the resource units may be associated with a frequency allocation range within the bandwidth of the channel. For example, a 20 MHz channel may include 256 78.125 kHz subcarriers. For example, the multi-device packet may include nine resource units that each cover 26 subcarriers of the bandwidth of the channel. For example, the multi-device packet may include 4 resource units that each cover 52 subcarriers of the bandwidth of the channel. For example, the multi-device packet may include 2 resource units that each cover 106 subcarriers of the bandwidth of the channel. In the example provided above, the multi-device packet may be divided into four resource units, however, in other examples, the number of resource units for the multi-device packet can be any number between 1-74 resource units. The number of resource units per multi-device packet may be static or dynamic. For example, the computing device 104 (e.g., the scheduler 110) may determine how may resource units to allocate to each multi-device packet based on the number of message payloads and associated packets the computing device 104 determines it can include in the multi-device packet in view of the current items in the output queues 106a-d.

For example, the computing device 104 may allocate, associate, determine, and/or assign two resource units of the multi-device packet 224 to the message payload 208 (e.g., cause the message payload 208 to use the data space associated with or included within the two resource units), with each resource unit holding one of the two packets 2c of the at least one first packet. Each of the resource unit (e.g., the first resource unit) and the another resource unit (e.g., the second resource unit) may be configured to be sent over a different range of frequencies (e.g., corresponding frequency allocation (e.g., the first frequency allocation) and the another frequency allocation (e.g., the second frequency allocation)) of the bandwidth of the channel. For example, the resource unit (e.g., the first resource unit) and the another resource unit (e.g., the second resource unit) may be combined into a single resource unit within the multi-device packet 224 to receive both packets from the same message payload 208. For example, the combined resource unit and another resource units may be a single resource unit corresponding to a frequency allocation of the bandwidth of the channel. For example, the frequency allocation may be a combination of the frequency allocation and the another frequency allocation.

For example, the computing device 104 may allocate, associate, determine, and/or assign a yet another resource unit (e.g., the third resource unit) of the multi-device packet 224 to the message payload 214 (e.g., cause the message payload 214 to use the data space associated with or included within the yet another resource unit), with the yet another resource unit (e.g., the third resource unit) holding the packet 3a of the message payload 214. For example, the yet another resource unit (e.g., the third resource unit) may be associated with or assigned a yet another frequency allocation (e.g., the third frequency allocation) within the bandwidth of the channel (e.g., cause the yet another resource unit to be sent within a frequency range in the yet another frequency allocation) that is different from the frequency allocation and the another frequency allocation and may be configured to be sent within a frequency range of the yet another frequency allocation. For example, the computing device 104 may allocate, associate, determine, and/or assign an additional resource unit (e.g., the fourth resource unit) of the multi-device packet 224 to the message payload 216 (e.g., cause the message payload 216 to use the data space associated with or included within the additional resource unit), with the additional resource unit (e.g., the fourth resource unit) holding the packet 3a of the message payload 216. For example, the additional resource unit (e.g., the fourth resource unit) may be associated with or assigned an additional frequency allocation (e.g., the fourth frequency allocation) within the bandwidth of the channel (e.g., cause the additional resource unit to be sent within a frequency range in the additional frequency allocation) that is different from the frequency allocation, the another frequency allocation, and the yet another frequency allocation and may be configured to be sent within a frequency range of the additional frequency allocation.

The computing device 104 may combine the packets from the message payloads 208, 214, and 216 into the multi-device packet 224 based on the resource unit allocations. For example, the computing device 104 may retrieve from the corresponding output queues 106b-c and insert into the multi-device packet 224 the at least one first packet (e.g., two packets 2c) from the message payload 208, the at least one second packet (e.g., packet 3a) from the message payload 214, and the at least one third packet (e.g., packet 3a) from the message payload 216. While the example embodiment shows a single packet for each associated resource unit, this is for example purposes only, as one or a plurality of packets may be packaged into each resource unit of the multi-device packet 224.

The multi-device packet 224 may be stored in a queue until it is sent by the computing device 104. For example, the queue for the multi-device packet 224 may be separate and distinct from the output queues 106a-d. For example, the computing device may store the multi-device packet 224 in one of the output queues 106a-d until the time for the multi-device packet 224 to be sent. For example, the computing device may store the multi-device packet 224 in the output queue associated with the packet having the highest QoS priority level. For example, with regard to the multi-device packet 224, the computing device 104 may store the multi-device packet 224 in the output queue 106b based on the highest priority packets of the multi-device packet being associated with QoS priority level 2 (e.g., video or medium level priority).

At 440, the multi-device packet (e.g., multi-device packet 224) may be sent. For example, the multi-device packet 224 may be sent from the computing device 104 to one or more other computing devices (e.g., one or more user devices 102a-d, 202a-d or gateway 114). For example, the multi-device packet 224 may be sent via a wireless communication from the computing device 104 to one or more other computing devices. For example, the wireless communication may be at least one of Wi-Fi, Bluetooth, Bluetooth Low-Energy, (BLE), Zigbee, Z-Wave, 6LoWPAN, Direct, near field communication (NFC). Long Range (LoRa), LoRaWAN, etc. For example, the multi-device packet 224 may comprise a first packet to be sent to a first destination and a second packet to be sent to a second destination different from the first destination. For example, the multi-device packet 224, comprising packets destined for multiple computing devices, may be sent to the multiple computing devices. For example, the multi-device packet 224, comprising packets for user device 202a and 202c, may be sent to both user device 202a and user device 202c. For example, the multi-device packet 226 comprising packets for user device 202b and 202d, may be sent to both user device 202b and user device 202d. For example, the multi-device packet 228 comprising packets for user device 202a and 202c, may be sent to both user device 202a and user device 202c. For example, the multi-device packet 222 comprising packets for user device 202a and 202b, may be sent to both user device 202a and user device 202b. For example, each multi-device packet 222-228 may be accessed from the scheduler 110 and/or the output queue for the computing device 104 and sent to the particular user devices simultaneously or substantially simultaneously. For example, the multi-device packet 224 may be sent by the computing device 104 simultaneously or substantially simultaneously to user device 202a and user device 202c.

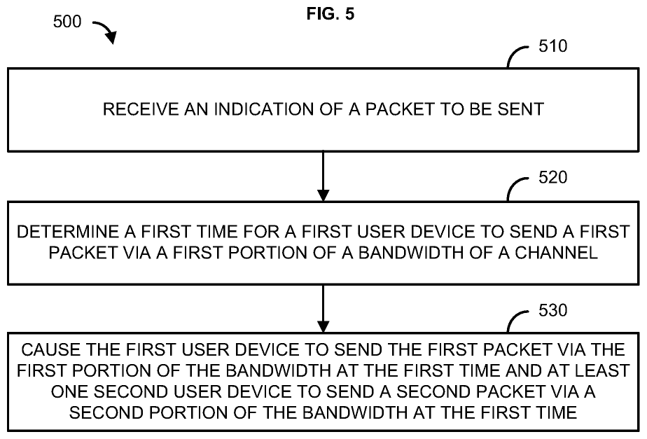

FIG. 5 is a flowchart showing an example method 500 for managing wireless communications received from one or more computing devices (e.g., user devices 102a-d, 202a-d). The method 500 may be completed by a computing device (e.g., the computing device 104, the gateway 114, or any other computing device).

A plurality of user devices (e.g., user devices 202a-d) may contend for an opportunity to communicate with the computing device 104. For example, each user device 202a-d may have, be associated with, or be assigned a specific QoS priority level. The QoS priority level for the user device 202a-d may be static (e.g., the particular user device always has the particular QoS priority level) or dynamic (e.g., the QoS priority level for the particular user device may change over time) based on the types of data (e.g., packets) it is communicating.

The QoS priority level for the particular user device 202a-d may affect or control how the particular user device 202a-d contends for an opportunity to communicate with the computing device 104. For example, user devices (e.g., user device 202c) assigned or associated with the highest QoS priority level (e.g., level 1, voice, or high priority) may have the shortest wait time between sending messages to the computing device 104 to signal to the computing device that it has data to send. For example, user devices (e.g., user device 202c) assigned or associated with the highest QoS priority level may also have the shortest or no delay time to send messages to the computing device 104 to signal to the computing device that it has data to send. This results in the user device 202c having the most opportunities to send messages to the computing device 104 to signal or contend for an opportunity to send its data to the computing device 104 and the best statistical probability to win the contention process against other user devices having a lower QoS priority level. For example, user devices (e.g., user device 202d) assigned or associated with the second highest QoS priority level (e.g., level 2, video, or medium priority) may have the second shortest wait time between sending messages to the computing device 104 and the second shortest delay time to signal to the computing device that it has data to send. This results in the user device 202d having the second most opportunities to send messages to the computing device 104 to signal or contend for an opportunity to send its data to the computing device 104 and a better chance to win the contention process against other user devices having a lower QoS priority level. For example, user devices (e.g., user device 202a) assigned or associated with the third highest QoS priority level (e.g., level 3, best efforts, or normal priority) may have the third shortest wait time between sending messages to the computing device 104 and the third shortest delay time to signal to the computing device that it has data to send. This results in the user device 202a having the third most opportunities to send messages to the computing device 104 to signal or contend for an opportunity to send its data to the computing device 104 and a better chance to win the contention process against other user devices having the lowest QoS priority level. For example, user devices (e.g., user device 202b) assigned or associated with the lowest QoS priority level (e.g., level 4, background, or low priority) may have the longest wait time between sending messages to the computing device 104 and the longest delay time to signal to the computing device that it has data to send. This results in the user device 202b having the least opportunities to send messages to the computing device 104 to signal or contend for an opportunity to send its data to the computing device 104 and the least statistical probability to win the contention process against other user devices having a higher QoS priority level.

Each of the user devices 202a-d may contend for an opportunity to communicate with the computing device based on the QoS priority level assigned or associated with each particular user device 202a-d. Once the particular user device 202a-d contends for and wins the opportunity to communicate with the computing device 104, a communication session between the user device and the computing device 104 may occur. For example, the computing device 104 may send or otherwise transmit a message to the user devices 202a-d. For example, the message may be configured to trigger a response from one or more of the plurality of user devices 202a-d to indicate messages that each user device 202a-d is waiting to send to the computing device 104. For example, the message may be a buffer status report trigger frame. For example, the message may request an accounting of the packets (e.g., buffered packets) or other data each of the user devices 202a-d has that are waiting to be sent to the computing device 104.

At 510, an indication may be received from one or more (e.g., each) of the user devices 202a-d. For example, each of the indications may be in the form of a message from the particular user device (e.g., user devices 202a-d) to the computing device 104. The indication may be received by the computing device 104. The indication may be associated with the one or more packets the particular user device 202a-d has buffered and is waiting to be sent to the computing device 104. For example, the indication may indicate the packets each particular user device 202a-d is waiting to send to the computing device 104. For example, the message may indicate the quantity of packets and/or amount of data in each message payload (e.g., message payloads 310-322 of FIG. 3). For example, the indication may indicate the QoS priority level assigned to or associated with each packet or message payload 310-322 to be sent to the computing device 104. For example, the indication may be received from each user device 202a-d based on the computing device 104 sending the request message (e.g., buffer status report trigger frame) to that particular user device 202a-d.

For example, an indication from the user device 202a may indicate that the user device 202a is waiting to send a message payload 310 having a packet assigned or associated with the third highest QoS priority level, a message payload 312 having a packet assigned or associated with the third highest QoS priority level, and a message payload 314 having a packet assigned or associated with the third highest QoS priority level. For example, an indication from the user device 202b may indicate that the user device 202b is waiting to send a message payload 316 having a packet assigned or associated with the lowest QoS priority level. For example, an indication from the user device 202d may indicate that the user device 202d is waiting to send a message payload 322 having three packets assigned or associated with the second highest QoS priority level, a message payload 324 having three packets assigned or associated with the second highest QoS priority level, and a message payload 326 having two packets assigned or associated with the second highest QoS priority level. Each indication may also indicate the order in which the particular user device 202a-d intends to send each message payload. The computing device 104 may provide the information from the messages to the scheduler 110 to schedule when each user device 202a-d will send its data to the computing device 104.

At 520, a first time for a user device (e.g., the user device 202d) to send at least one first packet to the computing device 104 via a portion (e.g., the first portion) of the bandwidth of the channel may be determined. The at least one first packet may be assigned or associated with a first QoS priority level. For example, the at least one first packet may be determined by the scheduler 110 of the computing device 104. For example, the computing device 104 may determine that the at least one first packet is to be wirelessly sent by the user device 202d to the computing device 104. For example, the at least one user device 202d may be determined based on the user device 202d winning the contention process vis-à-vis the other user devices, and obtaining the first opportunity to create a communication session with the computing device 104.

For example, the first time to send the at least one first packet may be determined. For example, the first time to send the at least one first packet may be determined based on a time to send packets to the computing device 104 (e.g., the time the computing device 104 is available to receive the at least one packet). For example, the first time to send may be determined based on a time (e.g., an earliest time, a scheduled time, etc.) the user device 202d is able to send the at least one first packet.

For example, the first QoS priority level may be a higher priority than a second QoS priority level. For example, the first QoS priority level may be one of voice priority, video priority, high priority or medium priority. For example, the first QoS priority level may be any priority level higher than the best efforts priority level and/or the normal priority level.

For example, the computing device 104 may determine the at least one first packet to be sent by evaluating the buffer status reports from each of the user devices 202a-d. For example, the computing device 104 may evaluate the buffer status reports, for packets to be sent, in priority level order, from highest priority level to lowest priority level. For example, the computing device 104 may first evaluate the buffer status report received (if one was sent) from the user device 202c based on the user device 202c being assigned or associated with the highest QoS priority level. The computing device 104 may next evaluate the buffer status report for the user device 202d based on the user device 202d being assigned or associated with the second highest QoS priority level. The computing device 104 may next evaluate the buffer status report for the user device 202a based on the user device 202a being assigned or associated with the third highest QoS priority level. The computing device 104 may next evaluate the buffer status report for the user device 202b based on it being assigned or associated with the lowest QoS priority level.

For example, the computing device 104 may evaluate the buffer status report for the user device 202c and determine that no message payloads or packets are waiting to be sent by the user device 202c. For example, the message 328 comprising the packets in message payloads 318 and 320 may have been previously sent by the user device 202c to the computing device 104. The computing device 104 may then evaluate the buffer status report for the user device 202d and determine a message payload (e.g., message payload 322) includes one or a plurality of packets (e.g., three packets) assigned or associated with a second highest QoS priority level (e.g., priority level 2, video, or medium) and the message payload is configured to be sent to the computing device 104. For example, the computing device 104 may determine the message payload 322 includes the at least one first packet that is a next-in-line packet assigned or associated with the first QoS priority level to be sent to the computing device 104. Further, based on the first QoS priority level being the highest QoS priority level for which packets (in message payloads) are waiting to be sent, the computing device 104 may determine that the at least one first packet within the message payload 322 will be at least part of the next packet to be sent to the computing device 104. For example, the computing device 104 may determine that the at least one first packet (e.g., data) within the message payload 322, is associated with a first portion of bandwidth of a channel. For example, the computing device 104 may determine that the at least one first packet within the message payload 322, when sent by the user device 202d, would use only a portion (e.g., a first portion) of the bandwidth of the channel used by the user device 202d to send, and/or by the computing device 104 to receive, the at least one first packet to the computing device 104. For example, the computing device 104 may determine the user device 202d may send, to the computing device 104, the at least one first packet via the first of the bandwidth of the channel at the first time.

For example, the computing device 104 may evaluate the total length field of the packet or packets that make up the message payload 322 to determine the total number of bytes within the packet. For example, the computing device 104 may determine the total number of bytes within the packet or packets of the message payload 322, based on the total length field of each packet, as the size of the packet or packets within the message payload 322 and may compare that amount to the amount of data space available in the bandwidth of the channel used by the computing device 104 for sending data to other computing devices. For example, the computing device 104 may evaluate the total length field of the packet or packets that make up the message payload 322 to determine the total number of bytes within the packet. The computing device 104 may then subtract the number of 32-bit words that make up the header (e.g., provided in the header length field of each packet) to determine the size of each packet that makes up the message payload 322. The computing device 104 may then compare the determined size of the message payload 322 (e.g., based on the combined size or sum of each packet within the payload 322) to the amount of data space available in the bandwidth of the channel used by the computing device 104 for receiving data (e.g., packets) from other computing devices (e.g., the user device 202d).

Based on the message payload 322 not needing all of the bandwidth of the channel for the computing device 104 to receive the at least one first packet in the message payload 322 from the user device 202d, the computing device 104 may evaluate the indication associated with the user device 202d, or with any other user devices being assigned or associated with the same QoS priority level, for other data (e.g., message payloads) to combine with the at least one first packet for sending by the user device 202d or another user device to the computing device 104 at the same first time within another portion of the bandwidth of the channel. For example, the computing device 104 may determine that there are no additional message payloads or packets assigned or associated with the same QoS priority level as the message payload 322. For example, the computing device 104 may determine that additional message payloads (e.g., message payloads 324, 326) include packets assigned or associated with the same QoS priority level as the at least one first packet in the message payload 322. The computing device 104 may determine that each of the additional message payloads 324, 326 include too much data (e.g., within the packets) to fit within the remaining portion of the bandwidth of the channel used by the computing device 104 for receiving the data of the at least one first packet from the user device 202d. For example, the computing device 104 may determine that neither of the additional message payloads 324, 326 may be combined with the message payload 322 to be sent at the same first time to the computing device 104 within the bandwidth of the channel used by the computing device 104 for receiving data from the user devices 202a-d. Based on the computing device 104 determining that no message payloads or packets assigned or associated with the same QoS priority level can be combined with the data of the message payload in the queue, the computing device 104 may determine if message payloads or packets assigned or associated with a lower and/or different QoS priority level than that of the at least one first packet in the message payload 322 can be sent to the computing device 104 at the same first time as the least one first packet using another portion (e.g., a second portion or a remaining portion) of the bandwidth of the channel.

At least one other user device (e.g., the user device 202a) to send at least one second packet to the computing device (e.g., computing device 104) via another portion (e.g., a second portion) of the bandwidth of the channel at the first time may be determined. For example, the at least one other user device may be determined by the scheduler 110 of the computing device 104. For example, the at least one other user device may be determined based on the one or more of the indications (e.g., an indication received from and associated with the at least one other user device). For example, the at least one other user device may be determined based on the another portion of the bandwidth of the channel. For example, the another portion of the bandwidth of the channel may be determined based on the computing device 104 needing to use only the portion of the bandwidth of the channel to receive the at least one first packet.

For example, the computing device 104 may determine that the at least one second packet is to be wirelessly transmitted or sent by the user device 202a to the computing device 104. For example, the at least one second packet may be assigned or associated with a second QoS priority level, different from the first QoS priority level of the at least one first packet. For example, the second QoS priority level may be a lower priority level than the first QoS priority level. For example, the second QoS priority may be one of video priority, best efforts priority, or background priority. For example, the second QoS priority level may be one of medium priority, normal priority, or low priority. For example, the second QoS priority level may be any priority level lower than the highest QoS priority level.

For example, the computing device 104 may determine that the at least one second packet would use a second portion (e.g., another portion or a remaining portion) of the bandwidth of the channel when sent by the user device 202a at the same first time and received by the computing device 104 at a same time or substantially the same time as the at least one first packet from the user device 202d.

For example, the computing device 104 may determine the at least one second packet, to be sent by a user device to a computing device 104, by evaluating the indications (e.g., the buffer status reports) for the user devices assigned or associated with a lower QoS priority level (e.g., user devices 202a-b) than the user device 202d for message payloads comprising one or more packets that would fit within the second portion (e.g., another portion or the remaining portion) of the bandwidth of the channel used by user device 202d to send at the first time, and the computing device 104 to receive, the at least one first packet. For example, the computing device 104 may evaluate the buffer status reports for the user devices for packets to be sent, in QoS priority level order, from highest QoS priority level device(s) to lowest QoS priority level device(s) for message payloads comprising one or more packets that would fit within the another portion of the bandwidth of the channel. For example, based on it being assigned or associated with the next highest QoS priority level as that of the user device 202d, the computing device 104 may first evaluate the indication (e.g., buffer status report) associated with the user device 202a for message payloads comprising one or more packets that would fit within the another portion of the bandwidth of the channel used by the computing device 104 to receive the at least one first packet from the user device 202d at the first time. The computing device 104 may optionally evaluate the buffer status report for the user device 202b for message payloads comprising one or more packets that would fit within the another portion of the bandwidth of the channel, based on the user device 202b sending packets assigned or associated with the lowest priority level, if no message payloads or packets are determined in the buffer of the user device 202a that would fit within the another portion of the bandwidth of the channel used by the user device 202d to send, and the computing device 104 to receive, the at least one first packet at the first time.

For example, the computing device 104 may determine the at least one second packet in message payload 310 in the buffer of user device 202a. For example, the computing device 104 may determine the at least one second packet in the message payload 310 is assigned or associated with the QoS priority level of level 3, best efforts, or normal and that the destination of the at least one second packet is the computing device 104. For example, the computing device 104 may determine the QoS priority level assigned or associated with the at least one second packet based on the QoS priority level assigned or associated with the particular user device or based on an evaluation of a field within a header of the packet (e.g., the type of service field of the IP header). For example, the computing device 104 may determine that the at least one second packet (e.g., packet 3a) in message payload 310 is associated with the another portion of the bandwidth of the channel. For example, the computing device 104 may determine that the at least one second packet in message payload 310 is of a data size that it could be sent via the second portion (e.g., another portion or the remaining portion) of the bandwidth of the channel used by the user device 202d to send at the first time, and the computing device 104 to receive, the at least one first packet.

For example, the computing device 104 may determine that the combination of the at least one first packet of the message payload 322 at the user device 202d and the at least one second packet of the message payload 310 at the user device 202a have a combined size (amount of data) that would only use a yet another portion (e.g., a third portion) of the bandwidth of the channel, wherein the third portion is greater than the portion of the bandwidth and the another portion of the bandwidth and wherein the bandwidth of the channel includes an additional fourth portion (e.g., another portion or the remaining portion) of the bandwidth of the channel. For example, the computing device 104 may determine at least one third packet to be sent by the user device 202a or another user device, and received by the computing device 104. For example, the at least one third packet may be determined based on the at least one first packet and the at least one second packet determined to need only the yet another portion of the bandwidth to be sent by the user devices at the first time and received by the computing device 104. For example, the at least one third packet may be assigned or associated with the second QoS priority level or a third QoS priority level, different from the first QoS priority level and the second QoS priority level. For example, the third QoS priority level may be a lower priority level than the second QoS priority level. For example, the third QoS priority level may be one of best efforts priority, or background priority. For example, the third QoS priority level may be one of normal priority, or low priority. For example, the third QoS priority level may be any priority level lower than the second QoS priority level.

For example, the computing device 104 may determine that the at least one third packet would use a fourth portion (e.g., another portion or the remaining portion) of the bandwidth of the channel for sending to the computing device 104 at the first time. For example, the at least one first packet, the at least one second packet, and the at least one third packet may be configured to be sent to the computing device 104.

For example, the computing device 104 may determine the at least one third packet to be sent to the computing device 104 by evaluating the indications (e.g., buffer status reports) of the user device that will send the at least one second packet (e.g., the user device 202a) and any other user device assigned or associated with the same or lower QoS priority level (e.g., the user device 202b) for message payloads comprising one or more packets that would fit within an additional portion (e.g., a fourth portion) of the bandwidth of the channel used by the user device 202d to send the at least one first packet and the user device 202a to send the at least one second packet at the first time to the computing device 104. For example, the computing device 104 may first evaluate the buffer status report for the user device 202a for additional message payloads comprising one or more packets associated with (e.g., that would fit within) the fourth portion of the bandwidth of the channel. Based on determining no message payloads or packets are in the buffer status report for the user device 202a that would fit within the remaining bandwidth of the channel, the computing device 104 may optionally evaluate the buffer status reports of the user device 202b for message payloads comprising one or more packets that would fit within the additional portion of the bandwidth of the channel. The process may continue in substantially the same manner until a sufficient number of packets are obtained from the plurality of message payloads from one or any number of user devices to use a predetermined amount of the bandwidth of the channel for simultaneous sending by the user devices of the at least one first packet, the at least one second packet, and any other included packets to the computing device 104.

At 530, the computing device 104 may cause the user device 202d to send the at least one first packet to the computing device 104 at a first time via the portion of the bandwidth of the channel and the user device 202a to send the at least one second packet to the computing device 104 at the first time via the another portion of the bandwidth of the channel. For example, the computing device 104 may cause the user device 202d to send the at least one first packet to the computing device 104 at the first time and the user device 202a to send the at least one second packet to the computing device 104 at the first time by sending or otherwise transmitting another indication or message to the user devices 202d, 202a that will be sending the at least one first packet and the at least one second packet (e.g., and any other additional packets identified to use the bandwidth of the channel for sending at the first time). For example, the message may indicate or include a first time that both the user device 202d is to send the at least one first packet to the computing device 104 using the portion of the bandwidth of the channel and the user device 202a is to send the at least one second packet to the computing device 104 using the another portion of the bandwidth of the channel. The message may also indicate the portion of the bandwidth to be used by the user device 202d and the another portion of the bandwidth to be used by the user device 202a. As discussed above, the computing device 104 may also send the message to other user devices if the bandwidth of the channel is divided into additional portions for use by other user devices. For example, the message may comprise a multi-device request to send (MU-RTS) trigger frame that includes the first time (e.g., a specific time) that the user device 202d and the user device 202d may send (e.g., simultaneously) the at least one first packet and the at least one second packet to the computing device 104, the portion of the bandwidth of the channel and the another portion of the bandwidth of the channel (e.g., and any other additional portions of the bandwidth of the channel as needed based on the number of message payloads of packets being sent to the computing device 104 at the same first time.

For example, the computing device 104 may determine to divide the bandwidth of the channel into a plurality of resource units. Each of the resource units may be associated with a frequency allocation range within the bandwidth of the channel. For example, a 20 MHz channel may include 256 78.125 kHz subcarriers. For example, the bandwidth of the channel may be divided into nine resource units that each cover 26 subcarriers of the bandwidth of the channel. For example, the bandwidth of the channel may be divided into 4 resource units that each cover 52 subcarriers of the bandwidth of the channel. For example, the bandwidth of the channel may be divided into 2 resource units that each cover 106 subcarriers of the bandwidth of the channel. In the example provided above, the bandwidth of the channel may be divided into four resource units, however, in other examples, the bandwidth of the channel may be divided into any number of resource units (e.g., any number between 1-74 resource units). For example, the computing device 104 (e.g., the scheduler 110) may determine how may resource units to allocate based on the number of message payloads and associated packets the computing device 104 determines it can have the user devices 202a-d send at the same time in view of the buffer status reports for the user devices 202a-d.

For example, the computing device 104 may allocate, associate, determine, and/or assign three resource units to the message payload 322 (e.g., cause the message payload 322 to use the data space associated with or included within the three resource units), with each resource unit holding one of the three packets 2d of the at least one first packet. Each of the resource unit (e.g., the first resource unit), the another resource unit (e.g., the second resource unit), and the yet another resource unit (e.g., the third resource unit) may be configured to be sent over a different range of frequencies (e.g., corresponding frequency allocation (e.g., the first frequency allocation) and the another frequency allocation (e.g., the second frequency allocation)) of the bandwidth of the channel. For example, the resource unit, the another resource unit, and the yet another resource unit may be combined into a single resource unit to receive the three packets from the same message payload 322. For example, the combined resource unit, the another resource unit, and the yet another resource unit may be a single resource unit corresponding to a frequency allocation of the bandwidth of the channel. For example, the frequency allocation may be a combination of the frequency allocation, the another frequency allocation, and the yet another frequency allocation (e.g., the third frequency allocation).

For example, the computing device 104 may allocate, associate, determine, and/or assign an additional resource unit (e.g., the fourth resource unit) to the message payload 310 (e.g., cause the message payload 310 to use the data space associated with or included within the additional resource unit), with the additional resource unit (e.g., the fourth resource unit) holding the packet 3a of the message payload 310. For example, the additional resource unit (e.g., the fourth resource unit) may be associated with or assigned an additional frequency allocation (e.g., the fourth frequency allocation) within the bandwidth of the channel (e.g., cause the additional resource unit to be sent within a frequency range in the additional frequency allocation) that is different from the frequency allocation, the another frequency allocation, and the yet another frequency allocation, and may be configured to be sent within a frequency range of the additional frequency allocation. While the example embodiment shows a single packet for each associated resource unit, this is for example purposes only, as one or a plurality of packets may be associated with each resource unit.

For example, each of the user device 202d and the user device 202a (e.g., and any other user devices using a portion of the bandwidth of the channel to send packets to the computing device 104) may send a clear to send (CTS) message to the computing device 104. For example, the CTS message may be sent based on the user device 202d and the user device 202a (e.g., and any other user devices using a portion of the bandwidth of the channel to send packets to the computing device 104) receiving the MU-RTS message from the computing device 104. For example, the computing device 104 may send a trigger frame to the user device 202d and the user device 202a (e.g., and any other user devices using a portion of the bandwidth of the channel to send packets to the computing device 104). For example, the trigger frame may be sent by the computing device 104 based on the computing device 104 receiving the CTS message from the user device 202d and the user device 202a (e.g., and any other user devices using a portion of the bandwidth of the channel to send packets to the computing device 104). For example, the CTS message may cause the user device 202d to send the at least one first packet to the computing device 104 at a first time and the user device 202a to send the at least one second packet to the computing device 104 at the first time

For example, the at least one first packet and the at least one second packet may be sent at the first time. For example, the at least one first packet may be sent at the first time by the user device 202d and the at least one second packet may be sent at the first time by the user device 202a. For example, additional packets determined to fit within bandwidth of the channel may be sent by the same or other user devices at the first time. For example, the at least one first packet and the at least one second packet may be sent to the computing device 104. For example, the at least one first packet may be received by the computing device 104 via a portion (e.g., the first portion) of the bandwidth of the channel and the at least one second packet may be received by the computing device 104 via another portion of the bandwidth of the channel that is different from and does not intersect with any portion of the portion of the bandwidth. For example, the computing device 104 may receive the at least one first packet and the at least one second packet at the same time or substantially the same time via the different portions of the bandwidth of the channel. For example, the at least one first packet and the at least one second packet may be received by the computing device 104 via a wireless communication from the user device 202d and the user device 202a. For example, the wireless communication may be at least one of Wi-Fi, Bluetooth, Bluetooth Low-Energy (BLE), Zigbee, Z-Wave, 6LoWPAN, WiFi Direct, near field communication (NFC), Long Range (LoRa), LoRaWAN, etc. For example, the user device 202d may send the at least one first packet to the computing device 104 via the communication path 330b and the user device 202a may send the at least one second packet to the computing device 104 via the communication path 330a.

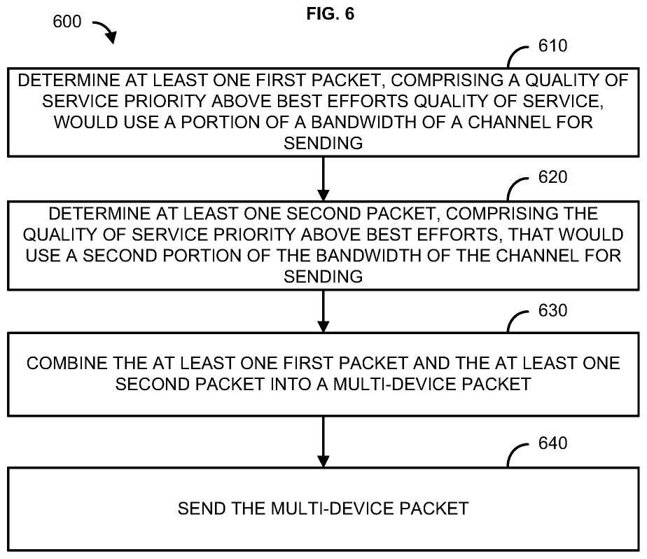

FIG. 6 is a flowchart showing an example method 600 for managing wireless communications to one or more other computing devices (e.g., user devices 102a-d, 202a-d). The method 600 may be completed by a computing device (e.g., the computing device 104, the gateway 114, or any other computing device). Further, the method 600 describes example communications between computing devices. While the example communications show direct communications between one computing device and another computing device, this is for example purposes only, as networks (e.g., network 116) or other computing devices not shown, may be intermediary devices along a communication path between one or more of the communications between the computing devices shown.

The computing device 104 may receive or generate a packet or message payload comprising a plurality of packets. The packet or message payload comprising the plurality of packets may be received from any computing device (e.g., user devices 102a-d, 202a-d, gateway 114, computing device 118 or any other computing device).

The computing device 104 may determine the quality of service (QoS) priority level assigned to or associated with each packet of the plurality of packets. For example, the classifier 108, or any other portion, of the computing device 104 may check the access categories 112 to determine what QoS priority level to assign to or associate with each packet of the plurality of packets.

For example, the computing device 104 may assign or associate the QoS priority level to each packet of the plurality of packets. For example, the classifier 108, or any other portion, of the computing device 104 may insert an indication of the assigned or associated QoS priority level into each packet of the plurality of packets. For example, the classifier 108 may insert the indication into a “type of service” field or another field of the IP header of each packet of the plurality of packets.

For example, one or more of the plurality of packets may have previously been assigned the QoS priority level (e.g., by another computing device and/or prior to being received by the computing device 104). For example, the computing device 104 may evaluate each of these packets to identify the indicator of the assigned or associated QoS priority level and determine, based on the indicator, the assigned or associated QoS priority level. For example, the computing device 104 may determine the assigned or associated QoS priority level of each packet by evaluating one or more fields (e.g., the type of service field in the IP header) of the packet.

The computing device 104 may place each packet of the plurality of packets into a queue. For example, the computing device 104 may include a plurality of queues (e.g., the output queues 106a-d). For example, the computing device 104 may include a separate queue for each QoS priority level. For example, the computing device 104 may store each packet in a queue that corresponds with the QoS priority level of the individual packet. For example, the output queue 106a may be configured as the queue for packets having the highest QoS priority level (e.g., voice or high priority). For example, the output queue 106b may be configured as the queue for packets having the second highest QoS priority level (e.g., video or medium priority). For example, the output queue 106c may be configured as the queue for packets having the third highest QoS priority level (e.g., best efforts or normal priority). For example, the output queue 106d may be configured as the queue for packets having the lowest QoS priority level (e.g., background or low priority). For example, the computing device 104 may prioritize sending packets having higher priority over those having lower priority. For example, the computing device 104 may include mechanisms (e.g., timers, data caps, etc.) to limit the amount of higher priority packets that are sent by the computing device 104 before lower priority packets are sent.

For example, the computing device 104 may store a portion of the plurality of the packets in one or more message payloads (e.g., message payloads 204-220) within the queue 106a-d that the packet was assigned to or associated with. For example, each message payload may include one or a plurality of packets. For example, each message payload may be constructed to be sent by the computing device 104 to a single other computing device (e.g., user devices 102a-d, 202a-d).

At 610, at least one first packet, to be sent or transmitted, may be determined. For example, the at least one first packet may be determined by the scheduler 110 of the computing device 104. For example, the computing device 104 may determine that the at least one first packet is to be wirelessly transmitted by the computing device 104. For example, the at least one first packet may have a first QoS priority level. For example, the first QoS priority level may be higher than the best efforts QoS priority level. For example, the first QoS priority level may be the voice QoS priority level or the video QoS priority level. For example, the first QoS priority level may be higher than the normal QoS priority level. For example, the first QoS priority level may be the medium QoS priority level or the high QoS priority level.

For example, the computing device 104 may determine the at least one first packet to be sent by evaluating the output queues 106a-b of the computing device. For example, the computing device 104 may evaluate the output queues, for packets to be sent, in priority level order, from highest priority level queue to lowest priority level queue. For example, the computing device 104 may first evaluate the output queue 106a based on it storing packets assigned or associated with the highest priority level (e.g., voice or high priority). The computing device 104 may next evaluate the output queue 106b based on it storing packets assigned or associated with the second highest priority level (e.g., video or medium priority).

For example, the computing device 104 may determine or identify one or more message payloads 204-212 in the output queues 106a-b. Each of the message payloads 204-212 may include one or more packets or groups of packets. The packets and the message payloads comprising the packets may be stored in their respective output queues 106a-b in chronological order and optionally configured to be sent by the computing device 104 to one or more other computing device in a first-in, first out (FIFO) order.

For example, the computing device 104 may evaluate the output queue 106a and determine that one or more message payloads and/or packets have been placed in the queue 106a to be sent. For example, the computing device 104 may determine a first message payload 204 (e.g., the first message payload 204 in the output queue 106a) includes one or a plurality of packets having a highest priority (e.g., priority level 1, voice, or high) and the message payload is configured to be sent to user device 202a. For example, the computing device 104 may determine the message payload 204 includes the at least one first packet that is a next packet having the first QoS priority level to be sent by the computing device 104. Further, based on the first QoS priority level being the highest QoS priority level for which packets (in message payloads) are waiting to be sent, the computing device 104 may determine that the at least one first packet within the message payload 204 will be at least part of the next packet to be sent by the computing device 104. For example, the computing device 104 may determine that the at least one first packet (e.g., data) within the message payload 204, when sent, would use only a portion of the bandwidth of the channel used by the computing device 104 for sending data to other computing devices.

For example, the computing device 104 may evaluate the total length field of the packet or packets that make up the message payload 204 to determine the total number of bytes within the packet. For example, the computing device 104 may determine the total number of bytes within the packet or packets of the message payload 204, based on the total length field of each packet, as the size of the packet or packets within the message payload 204 and may compare that amount to the amount of data space available in the bandwidth of the channel used by the computing device 104 for sending data to other computing devices. For example, the computing device 104 may evaluate the total length field of the packet or packets that make up the message payload 204 to determine the total number of bytes within the packet. The computing device 104 may then subtract the number of 32-bit words that make up the header (e.g., provided in the header length field of each packet) to determine the size of each packet that makes up the message payload 204. The computing device 104 may then compare the determined size of the message payload 204 (e.g., based on the combined size or sum of each packet within the message payload 204) to the amount of data space available in the bandwidth of the channel used by the computing device 104 for sending data to other computing devices.

Based on the message payload 204 not needing all of the bandwidth of the channel for sending the message payload to the user device 202a, the computing device 104 may evaluate the same output queue 106a, or any other packets or message payloads having the same QoS priority level, for other data (e.g., message payloads) to combine with the message payload for sending at the same time within the bandwidth of the channel.

At 620, at least one second packet to be sent or transmitted, may be determined. For example, the at least one second packet may be determined by the scheduler 110 of the computing device 104. For example, the at least one second packet may be determined based on the at least one first packet determined to need only the portion of bandwidth of the channel to be sent. For example, the computing device 104 may determine that the at least one second packet is to be wirelessly transmitted by the computing device 104. For example, the at least one second packet may have the first QoS priority level.

For example, the computing device 104 may determine that the at least one second packet would use another portion of the bandwidth (e.g., a second portion) of the channel for sending. For example, the destination for the at least one first packet and the at least one second packet may be the same or different. For example, the destination for the at least one first packet may be a computing device (e.g., the user device 202a) and the destination for the at least one second packet may be the same or another computing device (e.g., user device 202b).

For example, the computing device 104 may determine the at least one second packet to be sent by evaluating the other message payloads (e.g., message payload 206) in the same output queues as the message payload 204 (e.g., the output queues 106a) for message payloads comprising one or more packets that would fit within the remaining portion of the bandwidth of the channel used by the computing device 104.

For example, the computing device 104 may determine the at least one second packet in message payload 206. For example, the computing device 104 may determine the at least one second packet in the message payload 206 has the QoS priority level of 1, voice, or high, that is the same as the QoS priority level for the message payload 204, and that the destination of the at least one second packet is the user device 202b. For example, the computing device 104 may determine the QoS priority level for the at least one second packet based on the queue the packet is in or based on an evaluation of a field within a header of the packet (e.g., the type of service field of the IP header). For example, the computing device 104 may determine that the at least one second packet (e.g., packet 1b) in message payload 206 is of a data size that it would use (e.g., could be sent within) a second portion (e.g., a remaining portion) of the bandwidth of the channel for sending along with the at least one first packet in message payload 204. The process may continue in substantially the same manner until a sufficient number of packets are obtained from the plurality of message payloads having the first QoS priority level to use a predetermined amount of the bandwidth of the channel for simultaneous sending to other computing devices by the computing device 104.

At 630, the at least one first packet and the at least one second packet may be combined into the multi-device packet (e.g., multi-device packet 222). For example, the packets may be combined into the multi-device packet by the scheduler 110 of the computing device 104. For example, the computing device 104 may combine the at least one first packet (from message payload 204) and the at least one second packet (from message payload 206) into the multi-device packet 222.

For example, the computing device 104 may generate or determine the multi-device packet 222. The multi-device packet 222 may be divided into a plurality of resource units. Each of the resource units may be associated with a frequency allocation range within the bandwidth of the channel. For example, a 20 MHz channel may include 256 78.125 kHz subcarriers. For example, the multi-device packet may include nine resource units that each cover 26 subcarriers of the bandwidth of the channel. For example, the multi-device packet may include 4 resource units that each cover 52 subcarriers of the bandwidth of the channel. For example, the multi-device packet may include 2 resource units that each cover 106 subcarriers of the bandwidth of the channel. In the example provided above, the multi-device packet may be divided into four resource units, however, in other examples, the number of resource units for the multi-device packet can be any number between 1-74 resource units. The number of resource units per multi-device packet may be static or dynamic. For example, the computing device 104 (e.g., the scheduler 110) may determine how may resource units to allocate to each multi-device packet based on the number of message payloads and associated packets the computing device 104 determines it can include in the multi-device packet in view of the current items in the output queues 106a-b.

For example, the computing device 104 may allocate, associate, determine, and/or assign three resource units of the multi-device packet 222 to the message payload 204 (e.g., cause the message payload 204 to use the data space associated with or included within the three resource units), with each resource unit holding one of the three packets 1a of the at least one first packet. Each of the resource unit (e.g., the first resource unit), the another resource unit (e.g., the second resource unit), and the yet another resource unit (e.g., the third resource unit) may be configured to be sent over a different range of frequencies (e.g., corresponding frequency allocation (e.g., the first frequency allocation), the another frequency allocation (e.g., the second frequency allocation), and the yet another frequency allocation (e.g., the third frequency allocation)) of the bandwidth of the channel. For example, the resource unit, the another resource unit, and the yet another resource unit may be combined into a single resource unit within the multi-device packet 222 to receive all of the at least one first packet from the same message payload 204. For example, the combined resource unit, the another resource unit, and the yet another resource unit may be a single resource unit corresponding to a frequency allocation of the bandwidth of the channel. For example, the frequency allocation may be a combination of the frequency allocation, the another frequency allocation, and the yet another frequency allocation.

For example, the computing device 104 may allocate, associate, determine, and/or assign an additional resource unit (e.g., the fourth resource unit) of the multi-device packet 222 to the message payload 206 (e.g., cause the message payload 206 to use the data space associated with or included within the two resource units), with the additional resource unit (e.g., the fourth resource unit) holding the packet 1b of the message payload 206. For example, the additional resource unit (e.g., the fourth resource unit) may be associated with or assigned an additional frequency allocation (e.g., the fourth frequency allocation) within the bandwidth of the channel (e.g., cause the additional resource unit to be sent within a frequency range in the additional frequency allocation) that is different from the frequency allocation, the another frequency allocation, and the yet another frequency allocation and may be configured to be sent within a frequency range of the additional frequency allocation.

The computing device 104 may combine the packets from the message payloads 204 and 206 into the multi-device packet 222 based on the resource unit allocations. For example, the computing device 104 may retrieve from the output queue 106a and insert into the multi-device packet 222 the at least one first packet (e.g., three packets 1a) from the message payload 204 and the at least one second packet (e.g., packet 1b) from the message payload 206. While the example embodiment shows a single packet for each associated resource unit, this is for example purposes only, as one or a plurality of packets may be packaged into each resource unit of the multi-device packet 222.

The multi-device packet 222 may be stored in a queue until it is sent by the computing device 104. For example, the queue for the multi-device packet 222 may be separate and distinct from the output queues 106a-d. For example, the computing device 104 may store the multi-device packet 222 in one of the output queues 106a-d (e.g., the same output queue from which the packets were retrieved from) until the time for the multi-device packet 222 to be sent.

At 640, the multi-device packet (e.g., multi-device packet 222) may be sent. For example, the multi-device packet 222 may be sent from the computing device 104 to one or more other computing devices (e.g., one or more user devices 102a-d, 202a-d or the gateway 114). For example, the multi-device packet 222 may be sent via a wireless communication from the computing device 104 to one or more other computing devices. For example, the wireless communication may be at least one of Wi-Fi, Bluetooth, Bluetooth Low-Energy (BLE), Zigbee, Z-Ware, 6LoWPAN, WiFi Direct, near field communication (NFC). Long Range (LoRa), LoRaWAN, etc. For example, the multi-device packet 222, comprising packets destined for multiple computing devices, may be sent to the multiple computing devices. For example, the multi-device packet 222, comprising packets for user device 202a and 202b, may be sent to both user device 202a and user device 202b. For example, the multi-device packet 222 may be accessed from the scheduler 110 and/or the output queue for the computing device 104 and sent to the particular user devices simultaneously or substantially simultaneously. For example, the multi-device packet 222 may be sent by the computing device 104 simultaneously or substantially simultaneously to user device 202a and user device 202b.

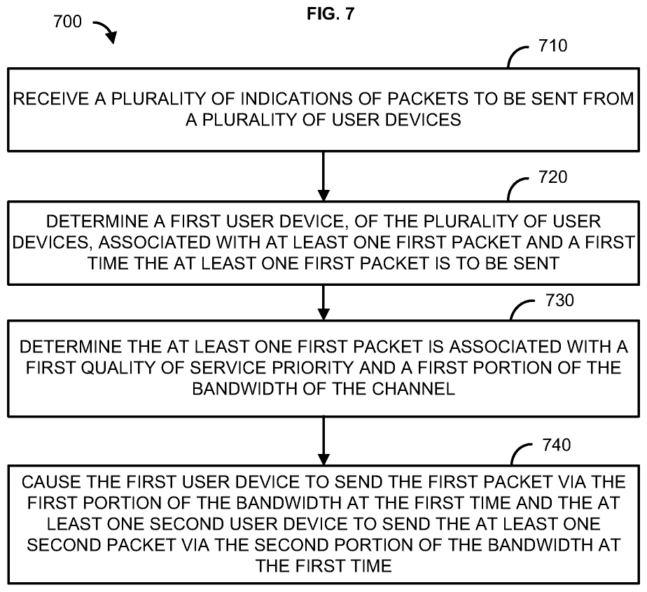

FIG. 7 is a flowchart showing an example method 700 for managing wireless communications received from one or more computing devices (e.g., user devices 102a-d, 202a-d). The method 700 may be completed by a computing device (e.g., the computing device 104, the gateway 114, or any other computing device).

A plurality of user devices (e.g., user devices 202a-d) may contend for an opportunity to communicate with the computing device 104. For example, each user device 202a-d may have, be associated with, or be assigned a specific QoS priority level. The QoS priority level for the user device 202a-d may be static (e.g., the particular user device always has the particular QoS priority level) or dynamic (e.g., the QoS priority level for the particular user device may change over time) based on the types of data (e.g., packets) it is communicating.

Each of the user devices 202a-d may contend for an opportunity to communicate with the computing device based on the QoS priority level assigned or associated with each particular user device 202a-d. Once the particular user device 202a-d contends for and wins the opportunity to communicate with the computing device 104, a communication session between the user device and the computing device 104 may occur. For example, the computing device 104 may send or otherwise transmit a message or indication to the user devices 202a-d. For example, the message or indication may be configured to trigger a response (e.g., an indication) from one or more of the plurality of user devices 202a-d to indicate messages or packets that each user device 202a-d is waiting to send to the computing device 104. For example, the message or indication from the computing device 104 to the user devices 202a-d may be a buffer status report trigger frame. For example, the message may request an accounting of the packets (e.g., buffered packets) or other data each of the user devices 202a-d has that are waiting to be sent to the computing device 104.

At 710, a plurality of indications (e.g., messages) associated with packets to be sent to the computing device (e.g., the computing device 104) may be received from one or more (e.g., each) of the plurality of user devices 202a-d. For example, each of the plurality of indications may be in the form of a message from a particular user device (e.g., one of user devices 202a-d) to the computing device 104. The indication may be received by the computing device 104. For example, each of the plurality of indications may indicate the packets each particular user device 202a-d of the plurality of user devices is waiting to send to the computing device 104. For example, each indication may indicate the quantity of packets and/or amount of data in each message payload (e.g., message payloads 310-322 of FIG. 3). For example, each indication may indicate the QoS priority level assigned to or associated with each packet or message payload 310-322 to be sent to the computing device 104 from the particular user device. For example, the plurality of indications may be received based on the computing device 104 sending the request message or indication (e.g., buffer status report trigger frame) to the plurality of user devices 202a-d.

Each indication may also indicate the order in which the particular user device 202a-d intends to send each message payload. The computing device 104 may provide the information from the indications to the scheduler 110 to schedule when each user device 202a-d will send its data (e.g., packets or message payloads) to the computing device 104.

At 720, a user device (e.g., user device 202d) of the plurality of user devices associated with at least one first packet to send to the computing device 104 and a first time the at least one first packet is to be sent may be determined. For example, the at least one first packet may be determined by the scheduler 110 of the computing device 104 based on one or more of the plurality of indications. For example, the computing device 104 may determine that the at least one first packet is to be wirelessly sent by the user device 202d to the computing device 104. For example, the at least one user device 202d may be determined based on the user device 202d winning the contention process vis-à-vis the other user devices, and obtaining the first opportunity to create a communication session with the computing device 104.

For example, the first time to send the at least one first packet may be determined based on one or more of the plurality of indications. For example, the first time to send may be determined based on the indication associated with (e.g., sent by) the user device 202d. For example, the first time to send the at least one first packet may be based on a time (an earliest time, a scheduled time, etc.) the user device 202d is available to send the at least one first packet to the computing device 104.

For example, the at least one first packet may be associated with the user device 202d based on the at least one first packet being a packet to be sent by the user device 202d to the computing device 104. For example, the computing device 104 may determine the at least one first packet to be sent by the user device 202d by evaluating the indications (e.g., the buffer status reports) received from each of the plurality of user devices 202a-d. For example, the computing device 104 may evaluate the indications, for packets to be sent, in priority level order, from highest QoS priority level to lowest QoS priority level. For example, the computing device 104 may evaluate the indication associated with the user device 202c and determine that no message payloads or packets are waiting to be sent by the user device 202c. For example, the message 328 comprising the packets in message payloads 318 and 320 may have been previously sent by the user device 202c to the computing device 104. The computing device 104 may then evaluate the indication associated with (e.g., received from) the user device 202d and determine a message payload (e.g., message payload 322) includes at least one first packet (e.g., three packets) configured to be sent to the computing device 104.

At 730, the computing device 104 may determine the at least one first packet is associated with a first QoS priority and the at least one first packet is associated with a first portion of bandwidth of a channel. For example, the determination may be made based on a first indication (e.g., message) associated with (e.g., sent from) the user device (e.g., user device 202d).

The at least one first packet of the user device 202d may be assigned or associated with the first QoS priority level. For example, the first QoS priority level for the at least one first packet may be provided or listed in the indication associated with the user device 202d. For example, the first QoS priority level for the at least one first packet may be indicated in one or more of the at least one first packet. For example, the first QoS priority level may be a higher priority level than a second QoS priority level. For example, the first QoS priority level may be one of voice priority, video priority, high priority or medium priority. For example, the first QoS priority level may be any priority level higher than the best efforts priority level and/or the normal priority level.

For example, the computing device 104 may determine that the at least one first packet (e.g., data) within the message payload 322, is associated with the portion (e.g., the first portion) of the bandwidth of a channel. For example, the computing device 104 may determine that the at least one first packet within the message payload 322, when sent by the user device 202d, would use only a portion (e.g., the first portion) of the bandwidth of the channel used by the user device 202d to send to the computing device 104, and/or by the computing device 104 to receive, the at least one first packet. For example, the computing device 104 may determine the user device 202d may send, to the computing device 104, the at least one first packet via the portion of the bandwidth of the channel at the first time.

For example, the computing device 104 may evaluate the total length field of the packet or packets that make up the message payload 322 to determine the total number of bytes within the packet. For example, the computing device 104 may determine the total number of bytes within the packet or packets of the message payload 322, based on the total length field of each packet, as the size of the packet or packets within the message payload 322 and may compare that amount to the amount of data space available in the bandwidth of the channel used by the computing device 104 for receiving data from other computing devices. For example, the computing device 104 may evaluate the total length field of the packet or packets that make up the message payload 322 to determine the total number of bytes within the packet. The computing device 104 may then subtract the number of 32-bit words that make up the header (e.g., provided in the header length field of each packet) to determine the size of each packet that makes up the message payload 322. The computing device 104 may then compare the determined size of the message payload 322 (e.g., based on the combined size or sum of each packet within the payload 322) to the amount of data space available in the bandwidth of the channel used by the computing device 104 for sending data to other computing devices.

Based on the message payload 322 not needing all of the bandwidth of the channel for the computing device 104 to receive the at least one first packet in the message payload 322 from the user device 202d, the computing device 104 may evaluate the indication associated with the user device 202d, or with any other user devices being assigned or associated with the same QoS priority level, for other data (e.g., message payloads) to combine with the at least one first packet for sending by the user device 202d or another user device to the computing device 104 at the same first time within another portion of the bandwidth of the channel. For example, the computing device 104 may determine that there are no additional message payloads or packets assigned or associated with the same QoS priority level as the message payload 322. For example, the computing device 104 may determine that additional message payloads (e.g., message payloads 324, 326) include packets assigned or associated with the same QoS priority level as the at least one first packet in the message payload 322. The computing device 104 may determine that each of the additional message payloads 324, 326 include too much data (e.g., within the packets) to fit within the remaining portion of the bandwidth of the channel used by the computing device 104 for receiving the data of the at least one first packet from the user device 202d. For example, the computing device 104 may determine that neither of the additional message payloads 324, 326 may be combined with the message payload 322 to be sent at the same first time to the computing device 104 within the bandwidth of the channel used by the computing device 104 for receiving data from the user devices 202a-d. Based on the computing device 104 determining that no message payloads or packets assigned or associated with the same QoS priority level can be combined with the data of the message payload in the queue, the computing device 104 may determine if message payloads or packets assigned or associated with a lower and/or different QoS priority level than that of the at least one first packet in the message payload 322 m be sent to the computing device 104 at the same first time as the least one first packet using another portion (e.g., a second portion or a remaining portion) of the bandwidth of the channel.

At least one other user device (e.g., user device 202a), of the plurality of user devices, associated with at least one second packet to be sent to the computing device (e.g., computing device 104) may be determined. For example, the at least one other user device may be determined based on the at least one packet being able to be sent via the portion of the bandwidth of the channel. For example, the at least one other user device may be determined based on the one or more of the indications (e.g., an indication received from and associated with the at least one other user device). For example, the at least one other user device may be determined based on another portion (e.g., a second portion) of the bandwidth of the channel. For example, the another portion of the bandwidth of the channel may be determined based on the computing device 104 needing to use only the portion of the bandwidth of the channel to receive the at least one first packet from the user device 202d.

For example, the computing device 104 may determine that the at least one second packet is to be wirelessly transmitted or sent by the user device 202a to the computing device 104. For example, the at least one second packet may be assigned or associated with a second QoS priority level, different from the first QoS priority level of the at least one first packet. For example, the second QoS priority level may be a lower priority level than the first QoS priority level. For example, the second QoS priority may be one of video priority, best efforts priority, or background priority. For example, the second QoS priority level may be one of medium priority, normal priority, or low priority. For example, the second QoS priority level may be any priority level lower than the highest QoS priority level.

For example, the computing device 104 may determine that the at least one second packet would use a second portion (e.g., another portion or a remaining portion) of the bandwidth of the channel when sent by the user device 202a at the same first time and received by the computing device 104 at a same time or substantially the same time as the at least one first packet from the user device 202d.

For example, the computing device 104 may determine the at least one second packet, to be sent by a user device to a computing device 104, by evaluating the indications (e.g., the buffer status reports) for the user devices assigned or associated with a lower QoS priority level (e.g., user devices 202a-b) than the user device 202d for message payloads comprising one or more packets that would fit within the second portion (e.g., another portion or the remaining portion) of the bandwidth of the channel used by user device 202d to send at the first time, and the computing device 104 to receive, the at least one first packet. For example, the computing device 104 may evaluate the buffer status reports for the user devices for packets to be sent, in QoS priority level order, from highest QoS priority level device(s) to lowest QoS priority level device(s) for message payloads comprising one or more packets that would fit within the another portion of the bandwidth of the channel. For example, based on it being assigned or associated with the next highest QoS priority level as that of user device 202d, the computing device 104 may first evaluate the indication (e.g., buffer status report) associated with the user device 202a for message payloads comprising one or more packets that would fit within the another portion of the bandwidth of the channel used by the computing device 104 to receive the at least one first packet from the user device 202d at the first time. The computing device 104 may optionally evaluate the indication for the user device 202b for message payloads comprising one or more packets that would fit within the another portion of the bandwidth of the channel, based on the user device 202b sending packets assigned or associated with the lowest priority level, if no message payloads or packets are determined in the buffer of the user device 202a that would fit within the another portion of the bandwidth of the channel used by the user device 202d to send, and the computing device 104 to receive, the at least one first packet at the first time.

For example, the computing device 104 may determine the at least one second packet in the message payload 310 in the buffer of user device 202a. For example, the computing device 104 may determine the at least one second packet in the message payload 310 is assigned or associated with the QoS priority level of level 3, best efforts, or normal and that the destination of the at least one second packet is the computing device 104. For example, the computing device 104 may determine the QoS priority level assigned or associated with the at least one second packet based on the QoS priority level assigned or associated with the particular user device or based on an evaluation of a field within a header of the packet (e.g., the type of service field of the IP header). For example, the computing device 104 may determine that the at least one second packet (e.g., packet 3a) in the message payload 310 is associated with the another portion of the bandwidth of the channel. For example, the computing device 104 may determine that the at least one second packet in the message payload 310 is of a data size that it could be sent via the second portion (e.g., another portion or the remaining portion) of the bandwidth of the channel used by the user device 202d to send at the first time, and the computing device 104 to receive, the at least one first packet.

At 740, the computing device 104 may cause the user device 202d to send the at least one first packet to the computing device 104 at a first time via the portion of the bandwidth of the channel and the user device 202a to send the at least one second packet to the computing device 104 at the first time via the another portion of the bandwidth of the channel. For example, the computing device 104 may cause the user device 202d to send the at least one first packet to the computing device 104 at the first time and the user device 202a to send the at least one second packet to the computing device 104 at the first time by sending or otherwise transmitting another indication or message to the user devices 202d, 202a that will be sending the at least one first packet and the at least one second packet (e.g., and any other additional packets identified to use the bandwidth of the channel for sending at the first time). For example, the message may indicate or include a first time that both the user device 202d is to send the at least one first packet to the computing device 104 using the portion of the bandwidth of the channel and the user device 202a is to send the at least one second packet to the computing device 104 using the another portion of the bandwidth of the channel. The message may also indicate the portion of the bandwidth to be used by the user device 202d and the another portion of the bandwidth to be used by the user device 202a. As discussed above, the computing device 104 may also send the message to other user devices if the bandwidth of the channel is divided into additional portions for use by other user devices. For example, the message may comprise a multi-device request to send (MU-RTS) trigger frame that includes the first time (e.g., a specific time) that the user device 202d and the user device 202d may send (e.g., simultaneously) the at least one first packet and the at least one second packet to the computing device 104, the portion of the bandwidth of the channel and the another portion of the bandwidth of the channel (e.g., and any other additional portions of the bandwidth of the channel as needed based on the number of message payloads of packets being sent to the computing device 104 at the same first time.

For example, the at least one first packet may be sent at the first time by the user device 202d and the at least one second packet may be sent at the first time by the user device 202a. For example, additional packets determined to fit within bandwidth of the channel may be sent by the same or other user devices at the first time. For example, the at least one first packet and the at least one second packet may be sent to the computing device 104. For example, the at least one first packet may be received by the computing device 104 via the portion of the bandwidth of the channel and the at least one second packet may be received by the computing device 104 via the another portion of the bandwidth of the channel that is different from and does not intersect with any portion of the portion of the bandwidth of the channel. For example, the at least one first packet and the at least one second packet may be received by the computing device 104 via a wireless communication from the user device 202d and the user device 202a. For example, the wireless communication may be at least one of Wi-Fi, Bluetooth, Bluetooth Low-Energy (BLE), Zigbee, Z-Wave, 6LoWPAN, WiFi Direct, near field communication (NFC), Long Range (LoRa), LoRaWAN, etc.

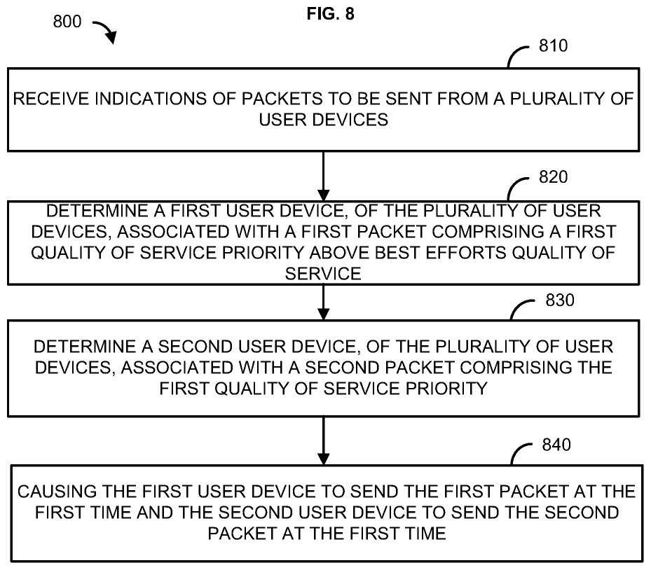

FIG. 8 is a flowchart showing an example method 800 for managing wireless communications received from one or more computing devices (e.g., user devices 102a-d, 202a-d). The method 800 may be completed by a computing device (e.g., the computing device 104, the gateway 114, or any other computing device).

A plurality of user devices (e.g., user devices 202a-d) may contend for an opportunity to communicate with the computing device 104. For example, each user device 202a-d may have or be assigned or associated with a specific QoS priority level. The QoS priority level for the user device 202a-d may be static (e.g., the particular user device always has the particular QoS priority level) or dynamic (e.g., the QoS priority level for the particular user device may change over time) based on the types of data it is communicating.

Each of the user devices 202a-d may contend for an opportunity to communicate with the computing device based on the QoS priority level for each particular user device 202a-d. Once the particular user device 202a-d contends for and wins the opportunity to communicate with the computing device 104, a communication session between the user device and the computing device 104 may occur. For example, the computing device 104 may send or otherwise transmit a message to the user devices 202a-d. For example, the message may be a buffer status report trigger frame. For example, the message may request an accounting of the buffered packets each of the user devices 202a-d has that are waiting to be sent to the computing device 104.

At 810, a message may be received from one or more of the user devices 202a-d. The message may be received by the computing device 104. The message may indicate the packets the particular user device 202a-d has buffered and are waiting to be sent to the computing device 104. For example, the message may indicate the quantity of packets and/or amount of data in each message payload (e.g., message payloads 310-322 of FIG. 3). For example, the message may indicate the QoS priority level for each packet or message payload 310-322. For example, the message may be received from each user device 202a-d based on the computing device sending the buffer status report trigger frame to that particular user device 202a-d.

For example, a message from the user device 202a may indicate that the user device 202a is waiting to send the message payload 310 having a packet with the third highest QoS priority level, the message payload 312 having a packet with the third highest QoS priority level, and the message payload 314 having a packet with the third highest QoS priority level. For example, a message from the user device 202b may indicate that the user device 202b is waiting to send the message payload 316 having a packet with the lowest QoS priority level. For example, a message from the user device 202d may indicate that the user device 202d is waiting to send the message payload 322 having three packets with the second highest QoS priority level, the message payload 324 having three packets with the second highest QoS priority level, and the message payload 326 having two packets with the second highest QoS priority level. Each message may also indicate the order in which the particular user device 202a-d intends to send each message payload. The computing device 104 may provide the information from the messages to the scheduler 110 to schedule when each user device 202a-d will send its data to the computing device 104.

At 820, at least one first packet, to be received from a user device (e.g., user device 202c) may be determined. The at least one first packet may have a first QoS priority level. For example, the at least one first packet may be determined by a scheduler 110 of the computing device 104. For example, the computing device 104 may determine that the at least one first packet is to be wirelessly sent by the user device 202d. For example, the first QoS priority level may be one of voice priority, video priority, high priority or medium priority. For example, the first QoS priority level may be any priority level higher than the best efforts QoS priority level and/or the normal QoS priority level.

For example, the computing device 104 may determine the at least one first packet to be received by evaluating the buffer status reports from each of the user devices 202a-d. For example, the computing device 104 may evaluate the buffer status reports, for packets to be sent, in priority level order, from highest priority level to lowest priority level. For example, the computing device 104 may first evaluate the buffer status report received from the user device 202c based on the user device 202c being assigned or associated with the highest priority level. The computing device 104 may next evaluate the buffer status report for the user device 202d based on the user device 202d being assigned or associated with the second highest priority level. The computing device 104 may next evaluate the buffer status report for the user device 202a based on the user device 202a being assigned or associated with the third highest priority level. The computing device 104 may next evaluate the buffer status report for the user device 202b based on it being assigned or associated with the lowest priority level. In examples where multiple user devices have the same QoS priority level, the buffer status reports for those user devices may be evaluated by the computing device 104 in the order that the user devices were able to successfully content for a communication session with the computing device 104 or based on any other desired order.

For example, the computing device 104 may evaluate the buffer status report for the user device 202c and determine a message payload (e.g., message payload 318) includes one or a plurality of packets having a highest priority (e.g., priority level 1, voice, or high) and the message payload 318 is configured to be sent to the computing device 104. For example, the computing device 104 may determine the message payload 318 includes the at least one first packet that is a next packet having the first QoS priority level to be sent by the user device 202a-d to the computing device 104. Further, based on the first QoS priority level being the highest QoS priority level for which packets (in message payloads) are waiting to be sent, the computing device 104 may determine that the at least one first packet within the message payload 318 will be at least part of the next packet to be received by the computing device 104. For example, the computing device 104 may determine that the at least one first packet (e.g., data) within the message payload 318, when received by the computing device 104, would use only a portion of the bandwidth of the channel used by the computing device 104 for receiving data from other computing devices (e.g., the user devices 202a-d).

For example, the computing device 104 may evaluate the total length field of the packet or packets that make up the message payload 318 to determine the total number of bytes within the packet. For example, the computing device 104 may determine the total number of bytes within the packet or packets of the message payload 318, based on the total length field of each packet, as the size of the packet or packets within the message payload 318 and may compare that amount to the amount of data space available in the bandwidth of the channel used by the computing device 104 for sending data to other computing devices. For example, the computing device 104 may evaluate the total length field of the packet or packets that make up the message payload 318 to determine the total number of bytes within the packet. The computing device 104 may then subtract the number of 32-bit words that make up the header (e.g., provided in the header length field of each packet) to determine the size of each packet that makes up the message payload 318. The computing device 104 may then compare the determined size of the message payload 318 (e.g., based on the combined size or sum of each packet within the payload 318) to the amount of data space available in the bandwidth of the channel used by the computing device 104 for sending data to other computing devices.

Based on the message payload 318 not needing all of the bandwidth of the channel for the computing device 104 to receive the message payload 318 from the user device 202c, the computing device 104 may evaluate the same buffer status report for the first user device 202c, or any other buffer status reports for other user devices having packets or message payloads having the same QoS priority level as the at least one first packet, for other data (e.g., message payloads of packets) to combine or associate with the at least one first packet for sending at the same time to the computing device 104 within the bandwidth of the channel.

At 830, at least one second packet, to be received from a user device may be determined. For example, the at least one second packet may be determined by the scheduler 110 of the computing device 104. For example, the at least one second packet may be determined based on the computing device 104 needing to use only a portion (e.g., a first portion) of the bandwidth of the channel to receive the at least one first packet from the user device 202c. For example, the computing device 104 may determine that the at least one second packet is to be wirelessly transmitted by the user device to the computing device 104. For example, the at least one second packet may have the first QoS priority level (e.g., the same QoS priority level as the at least one first packet). In the example of FIG. 3, the user device sending the at least one second packet is the same as the user device (e.g., user device 202c). However, in other examples, the user device sending the at least one second packet may be a different user device from the user device 202c and may be determined by the computing device based on an evaluation of the buffer status report associated with that other user device.

For example, the computing device 104 may determine that the at least one second packet would use a second portion (e.g., a remaining portion) of the bandwidth of the channel when received by the computing device 104 from the other user device (e.g., the same first user device 202c) at the same time or substantially the same time as the at least one first packet from the user device 202c.

For example, the computing device 104 may determine the at least one second packet, to be received by the computing device 104, by evaluating the buffer status reports for user devices assigned or associated with the same first QoS priority level as the user device 202c for message payloads comprising one or more packets that would fit within the remaining portion of the bandwidth of the channel used by the computing device 104 to receive the at least one first packet from the user device 202c. For example, based on it being the only user device of FIG. 3 being assigned or associated with the first QoS priority level, the computing device 104 may evaluate the buffer status report for the user device 202c for message payloads comprising one or more packets that would fit within the remaining portion of the bandwidth of the channel used by the computing device 104 to receive the at least one first packet from the user device 202c. However, in other examples where additional user devices are assigned or associated with the same first QoS priority level as the user device 202c, the computing device 104 may evaluate the buffer status reports for these other user devices.

For example, the computing device 104 may determine the at least one second packet in message payload 320 in the buffer of the user device 202c. For example, the computing device 104 may determine the at least one second packet in the message payload 320 has the QoS priority level of 1, voice, or high and that the destination of the at least one second packet is the computing device 104. For example, the computing device 104 may determine that the at least one second packet (e.g., packet 1c) in the message payload 320 is of a data size that it would use (e.g., could be sent within) a second portion (e.g., the remaining portion) of the bandwidth of the channel used by the computing device 104 to receive the at least one first packet from the user device 202c.

For example, the computing device 104 may determine that the combination of the at least one first packet of the message payload 318 and the at least one second packet of the message payload 320 at the user device 202c have a combined size (amount of data) that would only use yet another portion (e.g., a third portion) of the bandwidth of the channel, wherein the third portion is greater than the portion of the bandwidth and the another portion of the bandwidth and wherein the bandwidth of the channel includes an additional portion (e.g., a fourth portion) of the bandwidth of the channel. For example, the computing device 104 may determine at least one third packet to be received by the computing device 104 from the user device 202c or another user device. For example, the at least one third packet may be determined based on the at least one first packet and the at least one second packet determined to need only the third portion of bandwidth of the channel to be received by the computing device 104. For example, the at least one third packet may have the first QoS priority level or a second QoS priority level less than the first QoS priority level. For example, the second QoS priority level may be any priority level lower than the first QoS priority level.

For example, the computing device 104 may determine that the at least one third packet would use a fourth portion (e.g., the remaining portion) of the bandwidth of the channel for sending. For example, the at least one first packet, the at least one second packet, and the at least one third packet may be configured to be sent to the computing device 104 at the same time.

For example, the computing device 104 may determine the at least one third packet to be received by evaluating the buffer status reports of the user device that will send the at least one second packet (e.g., user device 202c) and any other user device having the same or lower QoS priority level (e.g., user devices 202a, 202b, 202d) for message payloads comprising one or more packets that would fit within the additional or remaining portion of the bandwidth of the channel used by the computing device 104 to receive the at least one first packet from the user device 202c and the at least one second packet from the user device 202c.

At 840, the computing device 104 may cause the user device 202c to send the at least one first packet to the computing device 104 at a first time and the user device (e.g., the same first user device 202c) to send the at least one second packet to the computing device 104 at the first time. For example, the computing device 104 may cause the user device 202c to send the at least one first packet to the computing device 104 at a first time and the user device (e.g., the same user device 202c) to send the at least one second packet to the computing device 104 at the first time by sending or otherwise transmitting a message to the user device 202c that will be sending the at least one first packet and the at least one second packet (e.g., and any other additional packets identified to use the bandwidth of the channel). For example, the message may indicate or include a first time that both the user device 202c is to send the at least one first packet to the computing device 104 using the portion of the bandwidth of the channel and the user device (e.g., the same user device 202c) is to send the at least one second packet to the computing device 104 using the another portion of the bandwidth of the channel. The message may also indicate the portion of the bandwidth to be used by the user device 202c and the another portion of the bandwidth to be used by the user device (e.g., the same user device 202c).

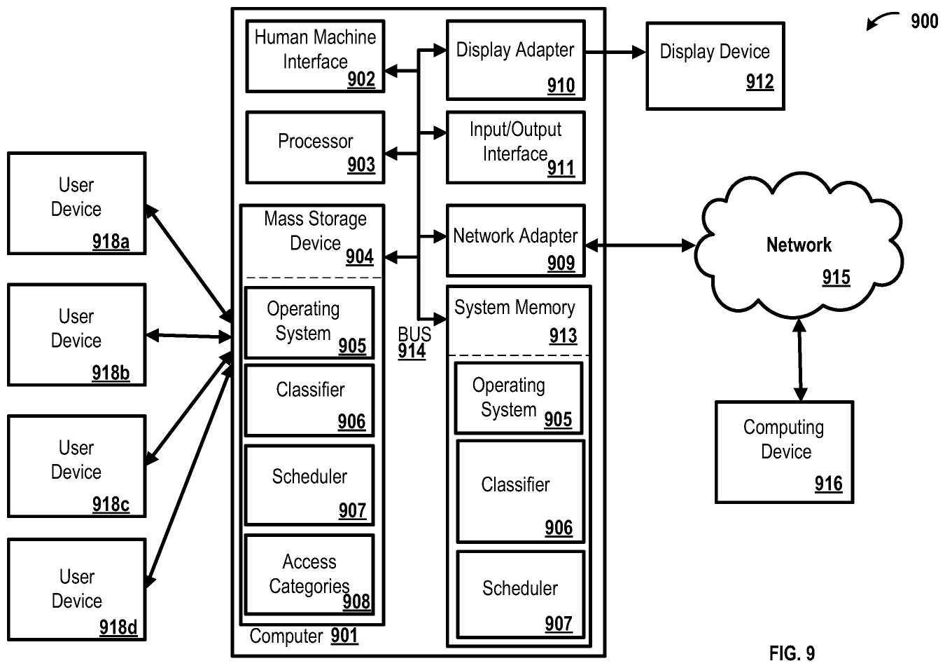

FIG. 9 shows a system 900 for managing wireless communications. Any one or more of the computing device 104, gateway 114, computing device 118, or user devices 102a-d, of FIG. 1 or the user devices 202a-d of FIGS. 2-3 may be a computer 901 as shown in FIG. 9.

The computer 901 may comprise one or more processors 903, a system memory 913, and a bus 914 that couples various components of the computer 901 including the one or more processors 903 to the system memory 913. In the case of multiple processors 903, the computer 901 may utilize parallel computing.

The bus 914 may comprise one or more of several possible types of bus structures, such as a memory bus, memory controller, a peripheral bus, an accelerated graphics port, and a processor or local bus using any of a variety of bus architectures.

The computer 901 may operate on and/or comprise a variety of computer-readable media (e.g., non-transitory). Computer-readable media may be any available media that is accessible by the computer 901 and includes, non-transitory, volatile and/or non-volatile media, and removable and non-removable media. The system memory 913 has computer-readable media in the form of volatile memory, such as random access memory (RAM), and/or non-volatile memory, such as read-only memory (ROM). The system memory 913 may store data and/or program modules such as an operating system 905, the classifier module 906, and scheduler module 907 that are accessible to and/or are operated on by the one or more processors 903.

The computer 901 may also comprise other removable/non-removable, volatile/non-volatile computer storage media. The mass storage device 904 may provide non-volatile storage of computer code, computer-readable instructions, data structures, program modules, and other data for the computer 901. The mass storage device 904 may be a hard disk, a removable magnetic disk, a removable optical disk, magnetic cassettes or other magnetic storage devices, flash memory cards, CD-ROM, digital versatile disks (DVD) or other optical storage, RAM, ROM, electrically erasable programmable read-only memory (EEPROM), and the like.

Any number of program modules may be stored on the mass storage device 904. An operating system 905, classifier module 906, and scheduler module 907 may be stored on the mass storage device 904. One or more of the operating system 905 classifier module 906, and scheduler module 907 (or some combination thereof) may comprise one or more program modules. Access categories 908 indicating the QoS priority level for particular forms or types of data may also be stored on the mass storage device 904.

A user may enter commands and information into the computer 901 via an input device (not shown). Such input devices include, but are not limited to, a keyboard, pointing device (e.g., a computer mouse or remote control), a microphone, a joystick, a scanner, tactile input devices such as gloves, and other body coverings, a motion sensor, and the like These and other input devices may be connected to the one or more processors 903 via a human-machine interface 902 that is coupled to the bus 914, but may be connected by other interface and bus structures, such as a parallel port, game port, an IEEE 1394 Port (also known as a Firewire port), a serial port, network adapter 909, and/or a universal serial bus (USB).

A display device 912 may also be connected to the bus 914 via an interface, such as a display adapter 910. It is contemplated that the computer 901 may have more than one display adapter 910 and the computer 901 may have more than one display device 912. A display device 912 may be a monitor, an LCD (Liquid Crystal Display), a light-emitting diode (LED) display, a television, smart lens, smart glass, and/or a projector. In addition to the display device 912, other output peripheral devices may comprise components such as speakers (not shown) and a printer (not shown) which may be connected to the computer 901 via Input/Output Interface 911. Any step and/or result of the methods may be output (or caused to be output) in any form to an output device. Such output may be any form of visual representation, including, but not limited to, textual, graphical, animation, audio, tactile, and the like. The display 912 and computer 901 may be part of one device, or separate devices.

The computer 901 may operate in a networked environment using logical connections to one or more computing devices, such as the remote computing device 916 and the user devices 918a-d. The remote computing device 916 may be a personal computer, computing station, workstation, portable computer, laptop computer, a network computer, a server or cloud computing device, and so on. The user devices 918a-d may comprise one or more of a client device, a personal computer, computing station, workstation, portable computer, laptop computer, mobile phone, tablet device, smartphone, smartwatch, activity tracker, smart apparel, smart accessory, security and/or monitoring device, a mobile device, a game system, a content output device, an IoT device, an edge device, an access point, a gateway, a network device, or the like. Logical connections between the computer 901 and the remote computing device 916 and the user devices 918a-d may be made via a network 915, such as a local area network (LAN) and/or a general wide area network (WAN) and one or more network devices (e.g., a router, an edge device, an access point or other common network nodes, such as a gateway). Such network connections may be through a network adapter 909. The network adapter 909 may be implemented in both wired and wireless environments. Such networking environments are conventional and commonplace in dwellings, offices, enterprise-wide computer networks, intranets, and the Internet.

Application programs and other executable program components such as the operating system 905, the classifier module 906, and the scheduler module 907 are shown herein as discrete blocks, although it is recognized that such programs and components may reside at various times in different storage components of the computing device 901, and are executed by the one or more processors 903 of the computer 901. An implementation of the classifier module 906 and/or the scheduler module 907 may be stored on or sent across some form of computer-readable media. Any of the disclosed methods may be performed by processor-executable instructions embodied on computer-readable media.

While specific configurations have been described, it is not intended that the scope be limited to the particular configurations set forth, as the configurations herein are intended in all respects to be possible configurations rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of configurations described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as exemplary only, with a true scope and spirit being indicated by the following claims.

What is claimed is:

1. A method comprising:
receiving, by a computing device a plurality of indications from a plurality of user devices, wherein the plurality of indications are associated with a plurality of packets to be sent by the plurality of user devices;
determining, based on the indications, a first time for a first user device, of the plurality of user devices, to send a first packet, of the plurality of packets, via a first portion of a bandwidth of a channel; and
causing the first user device to send the first packet at the first time via the first portion of the bandwidth of the channel and at least one second user device to send a second packet, of the plurality of packets, at the first time via a second portion of the bandwidth of the channel.

2. A method of claim 1, wherein the first packet is associated with a first quality of service (QoS) priority and the second packet is associated with a second QoS priority.

3. The method of claim 1, further comprising determining, based on the plurality of indications and the second portion of the bandwidth of the channel, the at least one second user device, of the plurality of user devices, to send the second packet via the second portion of the bandwidth of the channel at the first time.

4. The method of claim 1, wherein causing the first user device to send the first packet at the first time via the first portion of the bandwidth of the channel and the at least one second user device to send the second packet at the first time via the second portion of the bandwidth of the channel comprises sending, to the first user device and the at least one second user device, another indication to send the first packet via the first portion of the bandwidth and the second packet via the second portion of the bandwidth.

5. The method of claim 1, further comprising sending, to the plurality of user devices, a request for the plurality of indications associated with packets to be to be sent.

6. The method of claim 1, further comprising determining, based on the indication associated with the first user device, that no additional packets to be sent by the first user device fit within a remaining portion of the bandwidth of the channel.

7. The method of claim 1, wherein causing the first user device to send the first packet at the first time via the first portion of the bandwidth of the channel and the at least one second user device to send the second packet at the first time via the second portion of the bandwidth of the channel comprises sending, to the first user device and the at least one second user device, another indication to send the first packet and the second packet at the first time.

8. The method of claim 1, further comprising causing a third user device to send, to the computing device, at least one additional packet at the first time via an additional portion of the bandwidth.

9. The method of claim 1, further comprising:
determining, based on the indication associated with the first user device, a size of the first packet; and
determining, based on comparing the size of the first packet to a transmission capacity of the bandwidth of the channel, the first packet is to be sent via the first portion of the bandwidth of the channel.

10. A method comprising:
receiving, by a computing device and from a plurality of user devices, a plurality of indications associated with packets to be sent;
determining, based on one or more of the plurality of indications, a first user device, of the plurality of user devices, associated with at least one first packet and a first time the at least one first packet is to be sent;
determining, based on a first indication, of the plurality of indications, associated with the first user device, the at least one first packet is associated with a first quality of service (QoS) priority and the at least one first packet is associated with a first portion of a bandwidth of a channel;
causing the first user device to send, to the computing device, the at last one first packet at the first time via the first portion of the bandwidth of the channel and a second user device to send, to the computing device, at least one second packet, associated with a second QoS priority, at the first time via a second portion of the bandwidth of the channel.

11. The method of claim 10, further comprising determining, the at least one second packet will fit within the second portion of the bandwidth of the channel.

12. The method of claim 10, wherein causing the first user device to send the at least one first packet at the first time via the first portion of the bandwidth of the channel and the second user device to send the at least one second packet at the first time via the second portion of the bandwidth of the channel comprises:
sending, to the first user device, a second indication to send the at least one first packet on the first portion of the bandwidth at the first time; and
sending, to the second user device, a third indication to send the at least one second packet on the second portion of the bandwidth at the first time.

13. The method of claim 10, further comprising sending, to the plurality of user devices, a request for the plurality of indications associated with the packets to be sent by the plurality of user devices.

14. The method of claim 10, further comprising determining, based on the at least one first packet, the second user device, of the plurality of user devices, associated with the at least one second.

15. The method of claim 10, further comprising causing a third user device to send, to the computing device, at least one additional packet at the first time via an additional portion of the bandwidth.

16. The method of claim 10, wherein determining the at least one first packet is associated with the first portion of the bandwidth of the channel comprises:
determining, based on an indication, of the plurality of indications, associated with the first user device, a size of the at least one first packet; and
comparing the size of the at least one first packet to a transmission capacity of the bandwidth of the channel.

17. A method comprising:
determining, by a computing device, at least one first packet, associated with a first quality of service (QoS) priority and associated with a portion of a bandwidth of a channel;
determining, based on the portion of the bandwidth of the channel, at least one second packet, associated with a second QoS priority and associated with a second portion of the bandwidth of the channel;
combining the at least one first packet and the at least one second packet into a multi-device packet; and
sending the multi-device packet.

18. The method of claim 17, wherein a destination for the at least one first packet is a first user device and a second destination for the at least one second packet comprises at least one second user device, wherein sending the multi-device packet comprises sending the multi-device packet to the first user device and the at least one second user device.

19. The method of claim 17, further comprising:
receiving the at least one first packet comprising an indicator of the first QoS priority; and
storing, based on the indicator of the first QoS priority, the at least one first packet in a first queue associated with the first QoS priority.

20. The method of claim 17, further comprising:
determining no additional packets associated with the first QoS priority are available to send,
wherein determining the at least one second packet comprises determining, based on no additional packets associated with the first QoS priority are available to send, the at least one second packet associated with the second QoS priority.
